(19) United States
(12) Patent Application Publication
(10) Pub. No.: US 2026/0158843 A1
(43) Pub. Date: Jun. 11, 2026

(54) SHOCK ABSORBER

(71) Applicant: Hitachi Astemo, Ltd., Ibaraki (JP)

(72) Inventors: Eiichi KOMORI, Hitachinaka-shi (JP); Shinichi KAGAWA, Hitachinaka-shi (JP); Yutaka KURODA, Hitachinaka-shi (JP)

(21) Appl. No.: 18/725,836

(22) PCT Filed: Jan. 24, 2023
(86) PCT No.: PCT/JP2023/002006

§ 371 Date: Jul. 1, 2024

(30) Foreign Application Priority Data
Jan. 28, 2022 (JP) 2022-011408

(51) Int. Cl. B60G 15/06; F16F 13/00

(52) U.S. Cl. CPC B60G 15/063; F16F 13/007; B60G 2202/312; B60G 2204/1242; B60G 2206/41; B60G 2206/73; B60G 2800/162; F16F 2224/025; F16F 2232/08; F16F 2234/02

(57) ABSTRACT

The present shock absorber includes a cylinder, a piston provided inside the cylinder to be slidable, and a piston rod connected to the piston, and further includes a first movement suppression part provided in a cylindrical part of the cylinder and protruding outward in a radial direction, a spring receiving member having a cylinder-shaped cylindrical part covering at least a part of the cylinder, and a seating part on which a suspension spring is seated, and configured to be in contact with the first movement suppression part to suppress movement of the cylinder in an axial direction, and a second movement suppression part in contact with an outer circumferential surface of the cylinder and the cylindrical part to suppress relative movement in a circumferential direction between the cylinder and the spring receiving member.

### DESCRIPTION

### Technical Field

The present invention relates to a shock absorber.

Priority is claimed on Japanese Patent Application No. 2022-011408 filed on Jan. 28, 2022, the contents of which are incorporated herein by reference.

### Background Art

There is a shock absorber with a structure in which an annular groove is formed on an outer circumferential portion of a cylinder, a substantially C-shaped locking ring is fitted into the annular groove, and a spring seat is supported by the cylinder with the locking ring (for example, see Patent Document 1).

### CITATION LIST

### Patent Document

### [Patent Document 1]

Japanese Unexamined Patent Application, First Publication No. 2004-225890

### SUMMARY OF INVENTION

### Technical Problem

There is a demand for suppressing relative movement between a cylinder and a spring receiving member.

An objective of the present invention is to provide a shock absorber capable of suppressing relative movement between a cylinder and a spring receiving member.

### Solution to Problem

In order to achieve the above-described objective, a shock absorber according to a first aspect of the present invention includes a cylinder, a piston provided inside the cylinder to be slidable, and a piston rod connected to the piston, and includes a first movement suppression part provided in a cylindrical part of the cylinder and protruding outward in a radial direction, a spring receiving member having a cylinder-shaped cylindrical part covering at least a part of the cylinder, and a seating part on which a suspension spring is seated, and configured to be in contact with the first movement suppression part to suppress movement of the cylinder in an axial direction, and a second movement suppression part in contact with an outer circumferential surface of the cylinder and the cylindrical part to suppress relative movement in a circumferential direction between the cylinder and the spring receiving member.

A shock absorber according to a second aspect of the present invention includes a cylinder, a piston provided inside the cylinder to be slidable, and a piston rod connected to the piston, and includes a spring receiving member provided on an outer circumferential surface side of the cylinder, and including a cylinder-shaped cylindrical part covering at least a part of the cylinder, and a seating part on which a suspension spring is seated, a first movement suppression part provided on an outer circumferential surface of the cylinder and suppressing movement of the spring receiving member in an axial direction, a communication part provided in the cylindrical part to allow communication between an outer circumferential surface side of the cylinder and an outer circumferential surface side of the cylindrical part, and a second movement suppression part having at least a part of an inner circumferential surface in contact with an outer circumferential surface of the cylindrical part and an outer circumferential surface of the cylinder, and having a surface facing the cylindrical part and a surface facing the cylinder.

### Advantageous Effects of Invention

According to the present invention, relative movement between the cylinder and the spring receiving member can be suppressed.

### BRIEF DESCRIPTION OF DRAWINGS

FIG. 1 is a cross-sectional view showing a shock absorber of a first embodiment according to the present invention.

FIG. 2 is a partial perspective view showing a main part of the shock absorber of the first embodiment according to the present invention.

FIG. 3 is a cross-sectional view showing the main part of the shock absorber of the first embodiment according to the present invention.

FIG. 4 is a partial perspective view showing a main part of a shock absorber of a second embodiment according to the present invention.

FIG. 5 is a partial perspective view showing a main part of a shock absorber of a third embodiment according to the present invention.

FIG. 6 is a partial perspective view showing a main part of a shock absorber of a fourth embodiment according to the present invention.

FIG. 7 is a partial perspective view showing a main part of a shock absorber of a fifth embodiment according to the present invention.

FIG. 8 is a cross-sectional view showing the shock absorber of the fifth embodiment according to the present invention.

FIG. 9 is a partial perspective view showing a main part of a shock absorber of a sixth embodiment according to the present invention.

FIG. 10 is a cross-sectional view showing the shock absorber of the sixth embodiment according to the present invention.

FIG. 11 is a cross-sectional view showing a shock absorber of a seventh embodiment according to the present invention.

FIG. 12 is a partial perspective view showing a main part of the shock absorber of the seventh embodiment according to the present invention.

FIG. 13 is a bottom view showing the shock absorber of the seventh embodiment according to the present invention.

FIG. 14 is a partial perspective view in which a part is cut away showing a main part of a shock absorber of an eighth embodiment according to the present invention.

FIG. 15 is a partial perspective view showing a main part of a shock absorber of a ninth embodiment according to the present invention.

FIG. 16 is a cross-sectional view showing the main part of the shock absorber of the ninth embodiment according to the present invention.

FIG. 17 is a partial perspective view showing a main part of a shock absorber of a tenth embodiment according to the present invention.

FIG. 18 is a cross-sectional view showing the main part of the shock absorber of the tenth embodiment according to the present invention.

FIG. 19 is a partial perspective view showing a main part of a shock absorber of an eleventh embodiment according to the present invention.

FIG. 20 is a cross-sectional view showing the main part of the shock absorber of the eleventh embodiment according to the present invention.

### DESCRIPTION OF EMBODIMENTS

### First Embodiment

Embodiments according to the present invention will be described below with reference to the drawings.

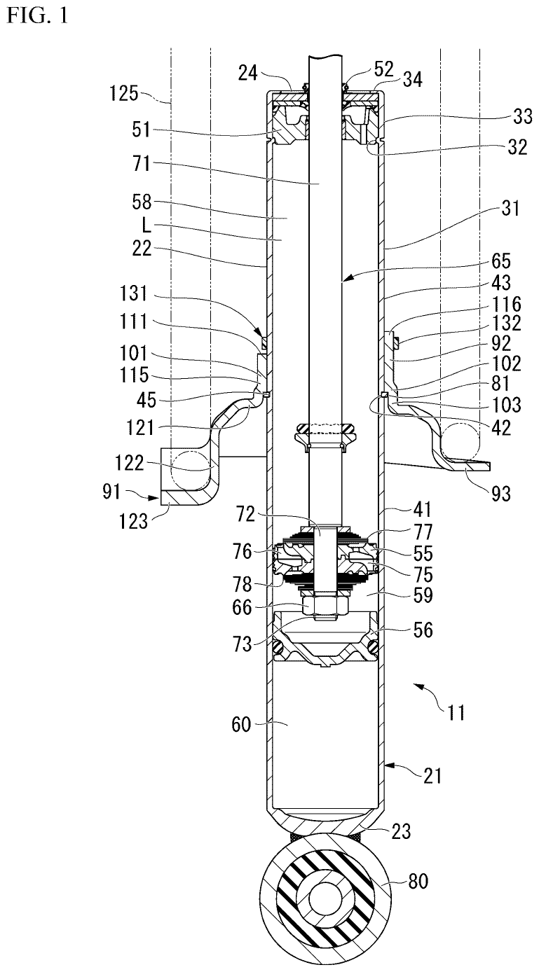

First, a shock absorber 11 of a first embodiment will be described with reference to FIGS. 1 to 3.

The shock absorber 11 shown in FIG. 1 is a shock absorber used in a suspension device of a vehicle such as an automobile or a railway vehicle. The shock absorber 11 is specifically a shock absorber used in a suspension device of an automobile.

The shock absorber 11 includes a cylinder 21. The shock absorber 11 is a single-tube type, a so-called mono-tube type, shock absorber having the single cylinder 21.

The cylinder 21 has a cylindrical shape, specifically, a bottomed cylindrical shape. The cylinder 21 has a barrel part 22 and a bottom part 23.

The barrel part 22 has a cylindrical shape.

The bottom part 23 has a disc shape and closes one end portion of the barrel part 22 in an axial direction. The other end portion of the barrel part 22 on a side opposite to the bottom part 23 is an opening 24. The cylinder 21 is an integrally molded product made of a single member of a metal.

The barrel part 22 includes a first cylindrical part 31 (cylindrical part), an intermediate locking part 32, a second cylindrical part 33, and an end portion locking part 34 in order from the bottom part 23 side in the axial direction.

The first cylindrical part 31 has a cylindrical shape over the entire axial length thereof, and includes a first large diameter part 41, a small diameter part 42, and a second large diameter part 43 in order from the bottom part 23 side in the axial direction.

An outer circumferential surface of the first large diameter part 41 on a radially outer side has a cylindrical surface shape, and an inner circumferential surface thereof on a radially inner side has a cylindrical surface shape that is coaxial with the outer circumferential surface.

An outer circumferential surface of the small diameter part 42 on a radially outer side has a cylindrical surface shape, and an inner circumferential surface thereof on a radially inner side has a cylindrical surface shape that is coaxial with the outer circumferential surface. The small diameter part 42 has an inner diameter equivalent to an inner diameter of the first large diameter part 41 and has an outer diameter smaller than an outer diameter of the first large diameter part 41.

An outer circumferential surface of the second large diameter part 43 on a radially outer side has a cylindrical surface shape, and an inner circumferential surface thereof on a radially inner side has a cylindrical surface shape that is coaxial with the outer circumferential surface. The second large diameter part 43 has an outer diameter equivalent to the outer diameter of the first large diameter part 41 and has an inner diameter equivalent to the inner diameter of the first large diameter part 41.

The first large diameter part 41, the small diameter part 42, and the second large diameter part 43 have a common central axis, and the central axis is a central axis of the first cylindrical part 31.

Therefore, the first cylindrical part 31 has a fitting groove 45 on an outer diameter side of the small diameter part 42 between the first large diameter part 41 and the second large diameter part 43 in the axial direction. The fitting groove 45 is recessed inward in the radial direction from the outer circumferential surface of the first large diameter part 41 and the outer circumferential surface of the second large diameter part 43. The fitting groove 45 has an annular shape.

The second cylindrical part 33 has a cylindrical shape over the entire axial length thereof. An outer circumferential surface of the second cylindrical part 33 on a radially outer side has a cylindrical surface shape, and an inner circumferential surface thereof on a radially inner side has a cylindrical surface shape that is coaxial with the outer circumferential surface. The second cylindrical part 33 has an outer diameter equivalent to an outer diameter of the first large diameter part 41 and the second large diameter part 43, and has an inner diameter equivalent to an inner diameter of the first large diameter part 41 and the second large diameter part 43.

The second cylindrical part 33 and the first cylindrical part 31 have a common central axis.

The intermediate locking part 32 is recessed inward in a radial direction from an outer circumferential surface of the second cylindrical part 33 and the outer circumferential surface of the second large diameter part 43. The intermediate locking part 32 protrudes inward from an inner circumferential surface of the second cylindrical part 33 and an inner circumferential surface of the second large diameter part 43 in a radial direction thereof. The intermediate locking part 32 has an annular shape.

The end portion locking part 34 protrudes inward in the radial direction of the second cylindrical part 33 from the inner circumferential surface of the second cylindrical part 33. The end portion locking part 34 has an annular shape. The inside of the end portion locking part 34 in the radial direction is the opening 24.

Here, the barrel part 22, before completion, has a cylindrical shape with a constant inner diameter over the entire axial length and a constant outer diameter over the entire axial length. When the barrel part 22 in an uncompleted state is plastically deformed, the intermediate locking part 32 and the end portion locking part 34 are formed, and the barrel part 22 is completed.

The shock absorber 11 includes a rod guide 51. The rod guide 51 has an annular shape and is fitted into the second cylindrical part 33 of the cylinder 21. The rod guide 51 is in contact with the intermediate locking part 32 on the bottom part 23 side in the axial direction.

The shock absorber 11 includes a seal member 52. The seal member 52 has an annular shape and is provided on the opening 24 side of the cylinder 21 with respect to the rod guide 51. Here, the seal member 52 is also fitted into the second cylindrical part 33 of the cylinder 21 similarly to the rod guide 51. The seal member 52 is sandwiched between the end portion locking part 34 and the rod guide 51 in an axial direction of the cylinder 21. The seal member 52 closes the opening 24 of the cylinder 21.

The shock absorber 11 includes a piston 55 and a free piston 56. Both the piston 55 and the free piston 56 are slidably provided inside the first cylindrical part 31 of the cylinder 21.

The piston 55 is on the opening 24 side with respect to the free piston 56 in the axial direction of the cylinder 21.

The piston 55 partitions two chambers, a first chamber 58 and a second chamber 59, in the cylinder 21. The free piston 56 partitions two chambers, the second chamber 59 and a gas chamber 60, in the cylinder 21.

The first chamber 58 is a portion between the piston 55 and the rod guide 51 in the cylinder 21. The second chamber 59 is a portion between the piston 55 and the free piston 56 in the cylinder 21. The gas chamber 60 is a portion between the free piston 56 and the bottom part 23 in the cylinder 21.

The first chamber 58 and the second chamber 59 are filled with an oil fluid L as a working fluid. The gas chamber 60 is filled with a gas G as a working fluid.

The shock absorber 11 includes a piston rod 65 and a nut 66. The piston rod 65 is inserted into the barrel part 22 of the cylinder 21 and has one axial end connected to the piston 55. A side of the piston rod 65 opposite to the piston 55 in the axial direction extends outward from the cylinder 21 through the opening 24. The piston 55 is connected to the piston rod 65 by the nut 66.

The piston rod 65 is made of a metal and has a main shaft part 71 and a mounting shaft part 72. The main shaft part 71 has a columnar shape. An outer circumferential surface of the main shaft part 71 is a cylindrical surface. The mounting shaft part 72 has a columnar shape and has an outer diameter smaller than an outer diameter of the main shaft part 71. A male screw 73 is formed on an outer circumferential portion of the mounting shaft part 72 on a side opposite to the main shaft part 71 in the axial direction. The piston 55 is fitted onto the mounting shaft part 72. The nut 66 is screwed onto the male screw 73 of the mounting shaft part 72.

The piston rod 65 extends from the cylinder 21 to the outside through the rod guide 51 and the seal member 52 at the main shaft part 71. In other words, the main shaft part 71 of the piston rod 65 is inserted into the rod guide 51 and the seal member 52. The main shaft part 71 of the piston rod 65 is in sliding contact with the rod guide 51 on an outer circumferential surface thereof. The piston rod 65 moves integrally with the piston 55 in the axial direction with respect to the cylinder 21 while being guided by the rod guide 51. The main shaft part 71 of the piston rod 65 is in sliding contact with the seal member 52 on an outer circumferential surface thereof. The seal member 52 seals between the second cylindrical part 33 of the cylinder 21 and the piston rod 65. The seal member 52 curbs leakage of the oil fluid L in the cylinder 21 to the outside.

A passage 75 and a passage 76 are formed in the piston 55. The passages 75 and 76 penetrate the piston 55 in an axial direction of the piston 55. The passages 75 and 76 allow communication between the first chamber 58 and the second chamber 59. The shock absorber 11 includes a disc valve 77. The disc valve 77 is provided on a side opposite to the bottom part 23 in the axial direction of the piston 55. The disc valve 77 has an annular shape and closes the passage 75 by coming into contact with the piston 55.

The shock absorber 11 has a disc valve 78. The disc valve 78 is provided on the bottom part 23 side in the axial direction of the piston 55. The disc valve 78 has an annular shape and closes the passage 76 by coming into contact with the piston 55.

A direction in which the piston rod 65 increases an amount of entry into the cylinder 21 is defined as a compression side. When the piston rod 65 moves to the compression side, the piston 55 moves in a direction in which the second chamber 59 is reduced. As a result, when a pressure in the second chamber 59 becomes higher than a pressure in the first chamber 58 by a predetermined value or higher, the disc valve 77 opens the passage 75 to allow the oil fluid L of the second chamber 59 to flow into the first chamber 58 through the passage 75. At that time, the disc valve 77 generates a damping force.

A direction in which the piston rod 65 increases an amount of protrusion from the cylinder 21 is defined as an extension side. When the piston rod 65 moves to the extension side, the piston 55 moves in a direction in which the first chamber 58 is reduced. As a result, when a pressure in the first chamber 58 becomes higher than a pressure in the second chamber 59 by a predetermined value or higher, the disc valve 78 opens the passage 76 to allow the oil fluid L of the first chamber 58 to flow into the second chamber 59 through the passage 76. At that time, the disc valve 78 generates a damping force.

A fixed orifice (not shown) is formed in at least one of the piston 55 and the disc valve 77. The fixed orifice allows the first chamber 58 and the second chamber 59 to communicate with each other through the passage 75 even in a state in which the disc valve 77 has closed the passage 75 to the maximum.

Also, a fixed orifice (not shown) is formed in at least one of the piston 55 and the disc valve 78. The fixed orifice allows the first chamber 58 and the second chamber 59 to communicate with each other through the passage 76 even in a state in which the disc valve 78 has closed the passage 76 to the maximum.

The free piston 56 moves in the axial direction with respect to the cylinder 21 according to a change in the amount of entry of the piston rod 65 into the first chamber 58. That is, when the piston rod 65 increases the amount of entry into the first chamber 58, the free piston 56 moves to the bottom part 23 side according to a volume thereof, and when the piston rod 65 reduces the amount of entry into the first chamber 58, the free piston 56 moves to a side opposite to the bottom part 23 according to the volume thereof.

The shock absorber 11 includes a mounting eye 80 fixed by welding to an outer surface of the bottom part 23 on a side opposite to the barrel part 22 in the axial direction. In the shock absorber 11, the piston rod 65 is disposed at an upper portion to be connected to a vehicle body side of a vehicle, and the mounting eye 80 is disposed at a lower portion to be connected to a wheel side of the vehicle. Therefore, the shock absorber 11 generates a damping force against movement of the wheel with respect to the vehicle body. Here, the mounting eye 80 is attached to a mounting part on the wheel side with a position thereof in a circumferential direction of the cylinder 21 at a prescribed position.

The shock absorber 11 includes a contact ring 81 (first movement suppression part). The contact ring 81 is made of a metal and is a C-shaped C ring formed by dividing a circular ring at one location in the circumferential direction. An outer circumferential surface of the contact ring 81 on a radially outer side has a cylindrical surface shape, and an inner circumferential surface thereof on a radially inner side has a cylindrical surface shape that is coaxial with the outer circumferential surface. A thickness of the contact ring 81 in the axial direction is smaller than a width thereof in the radial direction. The contact ring 81 is fitted into the fitting groove 45 provided in the first cylindrical part 31 of the cylinder 21. An inner diameter of the contact ring 81 before fitting into the fitting groove 45 is slightly smaller than an outer diameter of the small diameter part 42 of the cylinder 21, in other words, a diameter of a groove bottom of the fitting groove 45. Therefore, the contact ring 81 is in contact with and pressed against a groove bottom surface of the fitting groove 45 on a back side in a recess direction.

The contact ring 81 has an outer diameter larger than an outer diameter of the first large diameter part 41 and the second large diameter part 43 in a state of being fitted into the fitting groove 45. Therefore, the contact ring 81 is provided on the first cylindrical part 31 of the cylinder 21 and protrudes radially outward from the first cylindrical part 31 of the cylinder 21.

When the contact ring 81 is fitted into the fitting groove 45, movement thereof to the bottom part 23 side in the axial direction of the cylinder 21 is restricted by coming into contact with an end surface of the first large diameter part 41 on the small diameter part 42 side in the axial direction. Also, when the contact ring 81 is fitted into the fitting groove 45, movement thereof to a side opposite to the bottom part 23 side in the axial direction of the cylinder 21 is restricted by coming into contact with an end surface of the second large diameter part 43 on the small diameter part 42 side in the axial direction. Therefore, movement of the contact ring 81 to both sides in the axial direction of the cylinder 21 is restricted by being fitted into the fitting groove 45.

The shock absorber 11 includes a spring receiving member 91. The spring receiving member 91 is an integrally molded product made of a single member of a metal. The spring receiving member 91 has a cylindrical shape as a whole, and includes a cylinder-shaped cylindrical part 92 and a flange-shaped seating part 93. The cylindrical part 92 is at one end side of the spring receiving member 91 in the axial direction, and the seating part 93 is at the other end side of the spring receiving member 91 in the axial direction.

The cylindrical part 92 includes a small diameter cylindrical part 101, a contact part 102, and a large diameter cylindrical part 103 in order from a side opposite to the seating part 93 in the axial direction.

An outer circumferential surface of the small diameter cylindrical part 101 on a radially outer side has a cylindrical surface shape, and an inner circumferential surface thereof on a radially inner side has a cylindrical surface shape that is coaxial with the outer circumferential surface.

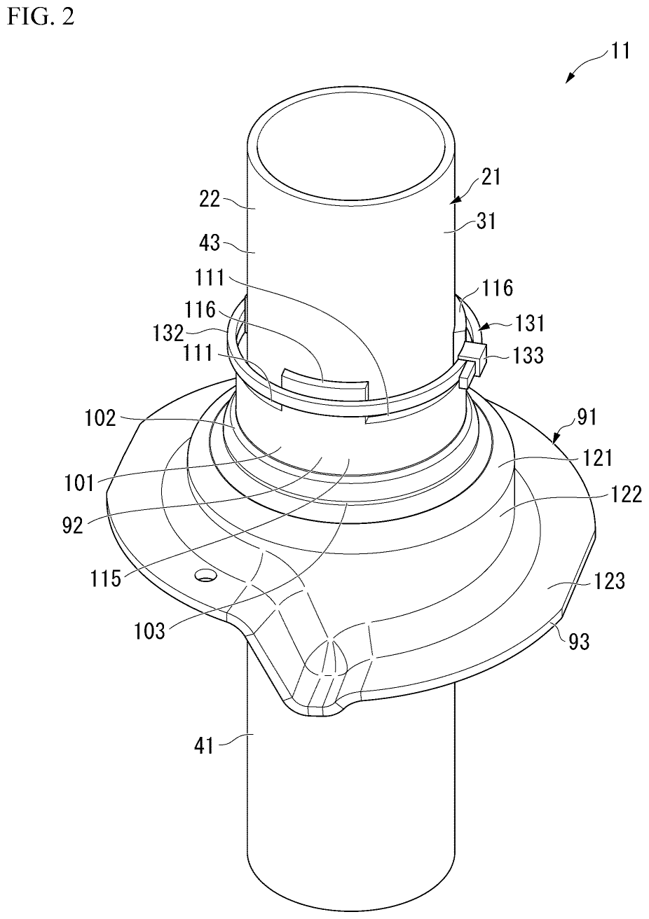

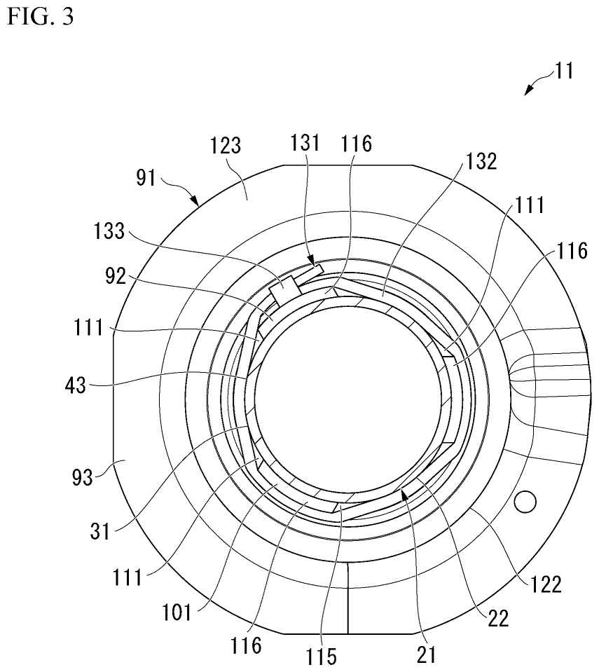

As shown in FIG. 2, the small diameter cylindrical part 101 has a groove part 111 (communication part) at a distal end portion on a side opposite to the contact part 102 in the axial direction. The groove part 111 is formed in a notch shape to be recessed from a distal end surface of the small diameter cylindrical part 101 on a side opposite to the contact part 102 in the axial direction to the contact part 102 side in the axial direction of the small diameter cylindrical part 101. The distal end surface of the small diameter cylindrical part 101 in which the groove part 111 is formed is an end surface of the cylindrical part 92 on a side opposite to the seating part 93 in the axial direction. The groove part 111 penetrates the small diameter cylindrical part 101 in the radial direction from an inner circumferential surface to an outer circumferential surface thereof. The groove part 111 is formed so that at least a part of an axial length of the cylindrical part 92 is reduced. As shown in FIG. 3, a plurality of, specifically three, groove parts 111 having the same shape are formed in the small diameter cylindrical part 101 at regular intervals in a circumferential direction of the small diameter cylindrical part 101.

As shown in FIG. 2, the small diameter cylindrical part 101 includes a base part 115 and an extension part 116. The base part 115 is provided on the contact part 102 side in the axial direction of the small diameter cylindrical part 101 and has a cylindrical shape over the entire axial length thereof. An end surface of the base part 115 on a side opposite to the contact part 102 in the axial direction is a plane extending perpendicular to a central axis of the base part 115. The extension part 116 extends from the base part 115 to a side opposite to the contact part 102 in the axial direction. All the groove parts 111 of the small diameter cylindrical part 101 are disposed so that groove bottom surfaces on a back side in a recess direction are disposed on the same plane. A plurality of, specifically three, extension parts 116 having the same shape are formed in the small diameter cylindrical part 101 at regular intervals in the circumferential direction of the small diameter cylindrical part 101. A length of the groove part 111 in the circumferential direction of the small diameter cylindrical part 101 is larger than that of the extension part 116.

As shown in FIG. 1, an outer circumferential surface of the large diameter cylindrical part 103 on a radially outer side has a cylindrical surface shape, and an inner circumferential surface thereof on a radially inner side has a cylindrical surface shape that is coaxial with the outer circumferential surface. The large diameter cylindrical part 103 has an inner diameter larger than an inner diameter of the small diameter cylindrical part 101 and has an outer diameter larger than an outer diameter of the small diameter cylindrical part 101.

The contact part 102 extends slightly outward in a radial direction of the small diameter cylindrical part 101 from an end edge portion of the small diameter cylindrical part 101 on the large diameter cylindrical part 103 side in the axial direction. The contact part 102 has an annular shape. An end edge portion of the contact part 102 on a radially outer side is connected to an end edge portion of the large diameter cylindrical part 103 on the small diameter cylindrical part 101 side in the axial direction.

The seating part 93 includes an intermediate flange part 121, a cylindrical part 122, and an end portion flange part 123 in order from the cylindrical part 92 side in the axial direction.

The intermediate flange part 121 extends outward in a radial direction of the large diameter cylindrical part 103 from an end edge portion of the large diameter cylindrical part 103 on a side opposite to the small diameter cylindrical part 101 in the axial direction.

The cylindrical part 122 extends from an outer circumferential edge portion on a radially outer side of the intermediate flange part 121 to a side opposite to the large diameter cylindrical part 103 in an axial direction of the intermediate flange part 121. The cylindrical part 122 has a cylindrical shape. The cylindrical part 122 has an inner diameter larger than an inner diameter of the large diameter cylindrical part 103, and has an outer diameter larger than an outer diameter of the large diameter cylindrical part 103.

The end portion flange part 123 extends outward in a radial direction of the cylindrical part 122 from an end edge portion of the cylindrical part 122 on a side opposite to the intermediate flange part 121 in the axial direction.

The spring receiving member 91 is placed over the barrel part 22 of the cylinder 21 from the opening 24 side in the axial direction with the end portion flange part 123 as the front. Then, the spring receiving member 91 is fitted into the second cylindrical part 33 of the cylinder 21 in the small diameter cylindrical part 101 of the cylindrical part 92, and then into the second large diameter part 43 of the first cylindrical part 31. Then, at the end of the fitting, the spring receiving member 91 is fitted to the contact ring 81 in the large diameter cylindrical part 103 to be in contact with an end surface of the contact ring 81 on the opening 24 side in the axial direction in the contact part 102.

In this state, the contact part 102 of the spring receiving member 91 moving to the bottom part 23 side beyond the contact ring 81 in the axial direction of the cylinder 21 is restricted. In other words, the spring receiving member 91 is in contact with the contact ring 81 and movement of the cylinder 21 in the axial direction is suppressed. In yet other words, the contact ring 81 is provided on an outer circumferential surface of the cylinder 21 to suppress movement of the spring receiving member 91 in the axial direction.

In this state, the spring receiving member 91 is disposed on the outer circumferential surface side of the cylinder 21.

Also, in this state, the cylinder-shaped cylindrical part 92 of the spring receiving member 91 covers at least a part of the cylinder 21. Specifically, the cylindrical part 92 covers a part of the first large diameter part 41 on the small diameter part 42 side in the axial direction, the small diameter part 42, and a part of the second large diameter part 43 on the small diameter part 42 side in the axial direction which are all a part of the first cylindrical part 31.

Also, in this state, as shown in FIG. 2, the spring receiving member 91 is configured such that the groove part 111 provided in the cylindrical part 92 allows communication between an outer circumferential surface side of the second large diameter part 43 of the cylinder 21 and an outer circumferential surface side of the small diameter cylindrical part 101 of the cylindrical part 92.

As shown in FIG. 1, a suspension spring 125 supporting the vehicle body is seated on the end portion flange part 123 of the spring receiving member 91 on a surface on the opening 24 side in the axial direction of the cylinder 21.

Here, the spring receiving member 91 is attached to the vehicle body of the vehicle with a position thereof in the circumferential direction of the cylinder 21 at a prescribed position. Therefore, the spring receiving member 91 and the mounting eye 80 are attached to the vehicle with their relative positions in the circumferential direction of the cylinder 21 prescribed.

As shown in FIG. 2, the shock absorber 11 includes a band member 131 (second movement suppression part). The band member 131 has a strip-shaped part 132 and a fixing part 133. The band member 131 is an integrally molded product made of one member formed in a string shape from a synthetic resin material. The band member 131 is a bundling band, a so-called a tie-wrap band.

The strip-shaped part 132 has flexibility and has a strip shape of a thin plate that is long in one direction. The strip-shaped part 132 is easily bent, particularly, in a thickness direction. Although not shown in the drawings, serrations having a large number of teeth disposed in a length direction of the strip-shaped part 132 are formed in the strip-shaped part 132 on one side in a thickness direction thereof.

The fixing part 133 is provided at one end portion of the strip-shaped part 132 in the length direction. The fixing part 133 has a rectangular cylindrical shape into which the strip-shaped part 132 can be inserted. The strip-shaped part 132 is inserted into the fixing part 133 from the other end portion in the length direction thereof. Thereby, the band member 131 becomes annular. At that time, the other end portion of the strip-shaped part 132 is positioned outside the one end portion in the radial direction. Also, at that time, the strip-shaped part 132 is inserted into the fixing part 133 so that the serrations (not shown) thereof face inward in the radial direction of the band member 131. Although not shown in the drawings, a claw part engaging with the serrations of the strip-shaped part 132 is formed inside the fixing part 133. The claw part allows movement of the strip-shaped part 132 in an insertion direction with respect to the fixing part 133, and restricts movement of the strip-shaped part 132 in a pull-out direction from the fixing part 133.

As shown in FIG. 1, the spring receiving member 91 is in a state of being in contact with the contact ring 81, which has been attached to the fitting groove 45 of the cylinder 21, at the contact part 102 of the cylindrical part 92. In this state, as shown in FIG. 2, the band member 131 is disposed to overlap the plurality of extension parts 116 and the plurality of groove parts 111 of the spring receiving member 91 in position in the axial direction of the small diameter cylindrical part 101, and is wound around outer surfaces of the plurality of extension parts 116 on an outer side in the radial direction of the small diameter cylindrical part 101. Then, the band member 131 is inserted into the fixing part 133 until the strip-shaped part 132 reaches a limit position in the insertion direction. Then, as shown in FIG. 3, the band member 131 is in a tightened state, and at least a part of the inner circumferential surface thereof is in contact with an outer circumferential surface of the cylindrical part 92 and an outer circumferential surface of the cylinder 21 to be in a state of having a surface facing the cylindrical part 92 and a surface facing the cylinder 21. Specifically, the band member 131 faces the outer surfaces of the plurality of extension parts 116 on an outer side in the radial direction of the small diameter cylindrical part 101 at a part of the serrations (not shown) on an inner circumferential surface of the strip-shaped part 132, and is brought into contact with and pressed against the outer surfaces. At the same time, the strip-shaped part 132 of the band member 131 enters the inside of the plurality of groove parts 111 of the small diameter cylindrical part 101 and faces the outer circumferential surface of the second large diameter part 43 of the cylinder 21 at a part of the serrations (not shown) on the inner circumferential surface thereof to be in contact with and pressed against the outer circumferential surface. The band member 131 is in contact with and pressed against the outer surfaces of the plurality of extension parts 116 on an outer side in the radial direction of the small diameter cylindrical part 101 at a plurality of regions of the strip-shaped part 132 spaced apart in the length direction. At the same time, the band member 131 is in contact with and pressed against the outer circumferential surface of the second large diameter part 43 at the plurality of regions of the strip-shaped part 132 spaced apart in the length direction.

Thereby, the band member 131, the spring receiving member 91, and the cylinder 21 are in a fixed state due to a frictional force of the strip-shaped part 132. In other words, due to the band member 131, movement of the spring receiving member 91 to both sides in the circumferential direction of the cylinder 21 with respect to the cylinder 21 is suppressed, and movement thereof to both sides in the axial direction of the cylinder 21 with respect to the cylinder 21 is suppressed. In other words, the band member 131 is in contact with the outer circumferential surface of the cylinder 21 and the cylindrical part 92 to suppress circumferential relative movement and axial relative movement between the cylinder 21 and the spring receiving member 91. Further, movement of the spring receiving member 91 to the bottom part 23 side in the axial direction of the cylinder 21 with respect to the cylinder 21 is restricted by the contact ring 81.

In shock absorbers, there are cases in which relative deviation occurs between a spring receiving member and a cylinder during transportation or the like before assembly into a vehicle. In such a case, work of restoring the relative relationship between the spring receiving member and the cylinder to an original state is necessary before assembly to the vehicle, and this takes time and effort. Therefore, in shock absorbers, it is required to suppress relative movement between the cylinder and the spring receiving member, particularly before assembly into the vehicle. Particularly, in a single-tube type shock absorber, since the spring receiving member is disposed directly on an outer circumferential surface of the cylinder in which a piston slides on an inner circumferential surface, it is not possible to fix the spring receiving member to the cylinder by welding or press-fitting which may deform the cylinder. It is also possible to increase a diameter of the cylinder in a range in which the piston does not slide and press-fit the spring receiving member into the portion, but in this case, a position at which the spring receiving member can be press-fitted is limited. It is also possible to press-fit the spring receiving member into the range of the cylinder in which the piston does not slide, but this will affect a degree of freedom in shape of the spring receiving member. For example, it is difficult when a spring is received in the vicinity of a center of the cylinder in the axial direction. Therefore, it is required to suppress relative movement between the cylinder and the spring receiving member while suppressing deformation of the cylinder, particularly before assembly into the vehicle.

Patent Document 1 described above discloses a shock absorber with a structure in which an annular groove is formed on an outer circumferential portion of a cylinder, a substantially C-shaped locking ring is fitted into the annular groove, and a spring seat is supported by the cylinder with the locking ring. Then, in the shock absorber, a rubber member is provided between an outer circumferential surface of the locking ring and an inner circumferential surface of the spring seat to suppress relative movement between the locking ring and the spring seat, thereby suppressing relative movement between the spring seat and the cylinder. However, the shock absorber of Patent Document 1 may not be able to sufficiently suppress the relative movement between the spring seat and the cylinder.

In contrast, in the shock absorber 11 of the first embodiment, the contact ring 81 provided on the first cylindrical part 31 of the cylinder 21 and protruding radially outward is in contact with the spring receiving member 91 to suppress axial movement of the spring receiving member 91 with respect to the cylinder 21. Also, in the shock absorber 11, the band member 131 is in contact with the outer circumferential surface of the cylinder 21 and the cylinder-shaped cylindrical part 92 of the spring receiving member 91 that covers at least a part of the cylinder 21 to suppress relative movement in the circumferential direction between the cylinder 21 and the spring receiving member 91. In this way, in the shock absorber 11, since the band member 131 is in contact with the outer circumferential surface of the cylinder 21 and the cylindrical part 92 of the spring receiving member 91, due to a frictional force thereof, relative movement in the circumferential direction between the cylinder 21 and the spring receiving member 91 can be effectively suppressed. Also, in the shock absorber 11, since the band member 131 is in contact with the outer circumferential surface of the cylinder 21 and the cylindrical part 92 of the spring receiving member 91, due to the frictional force thereof, relative movement in the axial direction between the cylinder 21 and the spring receiving member 91 can also be effectively suppressed. That is, in the shock absorber 11, the band member 131 suppresses axial movement of the spring receiving member 91 in a direction opposite to the bottom part 23 with respect to the cylinder 21, which is not restricted by the contact ring 81, in addition to axial movement of the spring receiving member 91 in a direction of the bottom part 23 with respect to the cylinder 21, which is restricted by the contact ring 81. Therefore, in the shock absorber 11, relative movement between the cylinder 21 and the spring receiving member 91 can be effectively suppressed. As a matter of course, since the band member 131 only needs to be in contact with the outer circumferential surface of the cylinder 21 and the cylindrical part 92 of the spring receiving member 91, deformation occurring in the cylinder 21 can be suppressed. Also, in the shock absorber 11, since there is no need to increase a diameter of the cylinder 21 in a range in which the piston 55 does not slide, and thus there is little effect on a shape of the spring receiving member 91, a degree of freedom in position and shape of the spring receiving member 91 is high, and the spring receiving member 91 can be disposed, for example, in the vicinity of a center of the cylinder 21 in the axial direction.

Also, the shock absorber 11 includes the groove part 111 provided on the cylindrical part 92 of the spring receiving member 91 to allow communication between the outer circumferential surface side of the cylinder 21 and the outer circumferential surface side of the cylindrical part 92. Therefore, in the shock absorber 11, the band member 131 can be easily brought into contact with the outer circumferential surface of the cylinder 21 and the outer circumferential surface of the cylindrical part 92.

Also, in the shock absorber 11, since the groove part 111 is formed so that at least a part of the axial length of the cylindrical part 92 is reduced, and particularly the groove part 111 is formed in a notch shape from an axial end surface of the cylindrical part 92, a configuration for the band member 131 to pass through the cylindrical part 92 in the radial direction can be easily formed.

Also, since the shock absorber 11 uses the band member 131 formed in a string shape, the band member 131 can be easily attached to be in contact with the outer circumferential surface of the cylinder 21 and the cylinder-shaped cylindrical part 92 of the spring receiving member 91.

Also, since the shock absorber 11 uses the band member 131 formed of a resin material, attachment of the band member 131 is further facilitated. Moreover, the shock absorber 11 can suppress an increase in weight due to the band member 131, and thus can suppress an increase in component costs.

### Second Embodiment

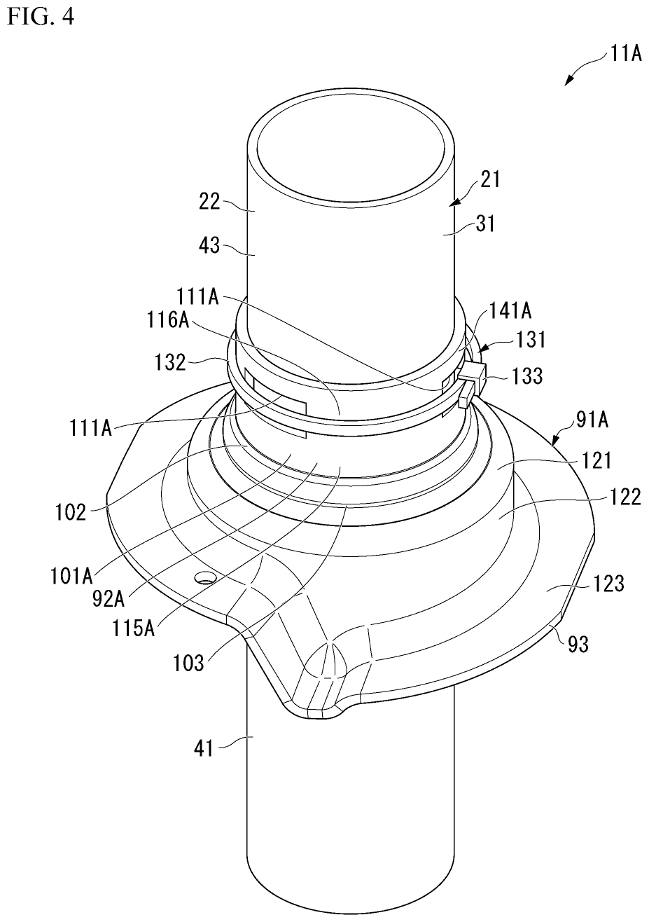

Next, a second embodiment will be described mainly on the basis of FIG. 4, focusing on differences from the first embodiment. Further, parts common to those in the first embodiment will be denoted by the same terms and the same reference signs.

As shown in FIG. 4, a shock absorber 11A of the second embodiment includes a spring receiving member 91A, which is partially different from the spring receiving member 91, instead of the spring receiving member 91. The spring receiving member 91A has a cylindrical part 92A, which is partially different from the cylindrical part 92, instead of the cylindrical part 92. The cylindrical part 92A has a small diameter cylindrical part 101A, which is partially different from the small diameter cylindrical part 101, instead of the small diameter cylindrical part 101.

The small diameter cylindrical part 101A is different from the small diameter cylindrical part 101 in that a through hole 111A is formed instead of the groove part 111. That is, the small diameter cylindrical part 101A has a through hole 111A (communication part) that penetrates the small diameter cylindrical part 101A in a radial direction at an intermediate part in an axial direction. In other words, the through hole 111A penetrates the small diameter cylindrical part 101A from an inner circumferential surface thereof to an outer circumferential surface thereof. A plurality of, specifically three, through holes 111A having the same shape are formed in the small diameter cylindrical part 101A at regular intervals in a circumferential direction of the small diameter cylindrical part 101A.

The small diameter cylindrical part 101A has a base part 115A, an extension part 116A, and a distal end part 141A. The base part 115A has substantially the same shape as the base part 115 and is different from the base part 115 in that an axial length is reduced. The extension part 116A extends from the base part 115A to a side opposite to a contact part 102 in an axial direction of the small diameter cylindrical part 101A. The distal end part 141A is provided on a side of the extension part 116A opposite to the base part 115A in the axial direction of the small diameter cylindrical part 101A and connects a plurality of extension parts 116A. The distal end part 141A has a cylindrical shape over the entire axial length thereof. The plurality of, specifically three, extension parts 116A having the same shape are formed in the small diameter cylindrical part 101A at regular intervals in the circumferential direction of the small diameter cylindrical part 101A.

Similarly to the spring receiving member 91, the spring receiving member 91A fits into a second large diameter part 43 of a first cylindrical part 31 at the small diameter cylindrical part 101A of the cylindrical part 92A and fits into a contact ring 81 (see FIG. 1) attached to a cylinder 21 at a large diameter cylindrical part 103 to be in contact with an end surface of the contact ring 81 on an opening 24 (see FIG. 1) side in the axial direction at the contact part 102.

In this state, the spring receiving member 91A is configured such that the through hole 111A provided in the cylindrical part 92A allows an outer circumferential surface side of the second large diameter part 43 of the cylinder 21 and an outer circumferential surface side of the small diameter cylindrical part 101A of the cylindrical part 92A to communicate with each other.

As described above, the spring receiving member 91A is in a state of being in contact with the contact ring 81 (see FIG. 1) attached to the cylinder 21 at the contact part 102 of the cylindrical part 92A. In this state, as shown in FIG. 4, a band member 131 is disposed to overlap the plurality of extension parts 116A and the plurality of through holes 111A of the spring receiving member 91A in position in the axial direction of the small diameter cylindrical part 101A, and is wound around outer surfaces of the plurality of extension parts 116A on an outer side in a radial direction of the small diameter cylindrical part 101A. Thereafter, the band member 131 is tightened. Then, at least a part of the inner circumferential surface of the band member 131 is in contact with an outer circumferential surface of the cylindrical part 92A and an outer circumferential surface of the cylinder 21, and is in a state of having a surface facing the cylindrical part 92A and a surface facing the cylinder 21. Specifically, the band member 131 faces the outer surfaces of the plurality of extension parts 116A on an outer side in the radial direction of the small diameter cylindrical part 101A at a part of serrations (not shown) on an inner circumferential surface of a strip-shaped part 132, and is brought into contact with and pressed against the outer surfaces. At the same time, the strip-shaped part 132 of the band member 131 enters the inside of the plurality of through holes 111A of the small diameter cylindrical part 101A and faces the outer circumferential surface of the second large diameter part 43 of the cylinder 21 at a part of the serrations (not shown) on the inner circumferential surface thereof to be in contact with and pressed against the outer circumferential surface. The band member 131 is in contact with and pressed against the outer surfaces of the plurality of extension parts 116A on an outer side in the radial direction of the small diameter cylindrical part 101A at a plurality of regions of the strip-shaped part 132 spaced apart in the length direction. At the same time, the band member 131 is in contact with and pressed against the outer circumferential surface of the second large diameter part 43 at the plurality of regions of the strip-shaped part 132 spaced apart in the length direction.

Thereby, the band member 131, the spring receiving member 91A, and the cylinder 21 are in a fixed state due to a frictional force of the strip-shaped part 132. In other words, due to the band member 131, movement of the spring receiving member 91A to both sides in a circumferential direction of the cylinder 21 with respect to the cylinder 21 is suppressed, and movement thereof to both sides in an axial direction of the cylinder 21 with respect to the cylinder 21 is suppressed. In other words, the band member 131 is in contact with the outer circumferential surface of the cylinder 21 and the cylindrical part 92A to suppress circumferential relative movement and axial relative movement between the cylinder 21 and the spring receiving member 91A. Further, movement of the spring receiving member 91A to a bottom part 23 (see FIG. 1) side in the axial direction of the cylinder 21 with respect to the cylinder 21 is restricted by the contact ring 81 (see FIG. 1).

In the shock absorber 11A of the second embodiment, the band member 131 is in contact with the outer circumferential surface of the cylinder 21 and the cylinder-shaped cylindrical part 92A of the spring receiving member 91A that covers at least a part of the cylinder 21 to suppress relative movement in the circumferential direction between the cylinder 21 and the spring receiving member 91A. In this way, in the shock absorber 11A, since the band member 131 is in contact with the outer circumferential surface of the cylinder 21 and the cylindrical part 92A of the spring receiving member 91A, due to a frictional force thereof, relative movement in the circumferential direction between the cylinder 21 and the spring receiving member 91A can be effectively suppressed. Also, in the shock absorber 11A, since the band member 131 is in contact with the outer circumferential surface of the cylinder 21 and the cylindrical part 92A of the spring receiving member 91A, due to the frictional force thereof, relative movement in the axial direction between the cylinder 21 and the spring receiving member 91A can also be effectively suppressed. That is, in the shock absorber 11A, the band member 131 suppresses axial movement of the spring receiving member 91A in a direction opposite to the bottom part 23 (see FIG. 1) with respect to the cylinder 21, which is not restricted by the contact ring 81 (see FIG. 1), in addition to axial movement of the spring receiving member 91A in a direction of the bottom part 23 with respect to the cylinder 21, which is restricted by the contact ring 81. Therefore, in the shock absorber 11A, relative movement between the cylinder 21 and the spring receiving member 91A can be effectively suppressed. As a matter of course, in the shock absorber 11A, since the band member 131 only needs to be in contact with the outer circumferential surface of the cylinder 21 and the cylindrical part 92A of the spring receiving member 91A, deformation occurring in the cylinder 21 can be suppressed.

Also, the shock absorber 11A includes the through hole 111A provided in the cylindrical part 92A of the spring receiving member 91A to allow communication between the outer circumferential surface side of the cylinder 21 and the outer circumferential surface side of the cylindrical part 92A. Therefore, in the shock absorber 11A, the band member 131 can be easily brought into contact with the outer circumferential surface of the cylinder 21 and the outer circumferential surface of the cylindrical part 92A.

Also, in the shock absorber 11A, since the through hole 111A is formed by penetrating the cylindrical part 92A in the radial direction, a configuration for the band member 131 to pass through the cylindrical part 92A in the radial direction can be easily formed.

### Third Embodiment

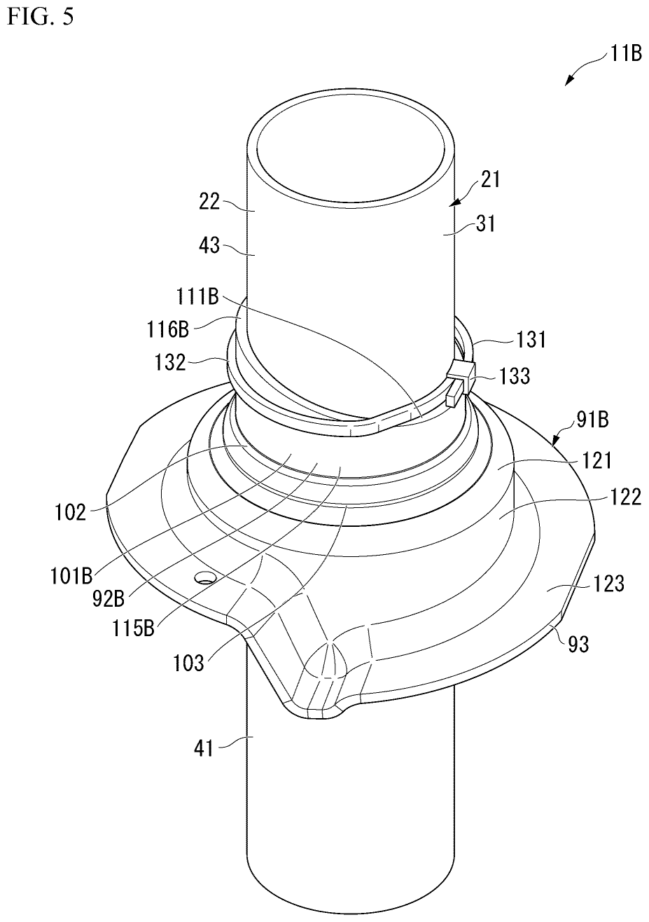

Next, a third embodiment will be described mainly on the basis of FIG. 5, focusing on differences from the first embodiment. Further, parts common to those in the first embodiment will be denoted by the same terms and the same reference signs.

As shown in FIG. 5, a shock absorber 11B of the third embodiment includes a spring receiving member 91B, which is partially different from the spring receiving member 91, instead of the spring receiving member 91. The spring receiving member 91B has a cylindrical part 92B, which is partially different from the cylindrical part 92, instead of the cylindrical part 92. The cylindrical part 92B has a small diameter cylindrical part 101B, which is partially different from the small diameter cylindrical part 101, instead of the small diameter cylindrical part 101.

The small diameter cylindrical part 101B is different from the small diameter cylindrical part 101 in that a notch part 111B is formed instead of the groove part 111. That is, the small diameter cylindrical part 101B has the notch part 111B (communication part), which is cut out so that at least a part of an axial length of the small diameter cylindrical part 101B is reduced, formed at a distal end portion on a side opposite to a contact part 102 in an axial direction thereof. Specifically, the notch part 111B has a shape obtained by cutting the small diameter cylindrical part 101B along a plane that is not perpendicular to a central axis thereof.

The small diameter cylindrical part 101B has a base part 115B and an extension part 116B. The base part 115B is provided on the contact part 102 side in the axial direction of the small diameter cylindrical part 101B, and has a cylindrical shape over the entire axial length. The extension part 116B protrudes from the base part 115B to a side opposite to the contact part 102 in the axial direction of the small diameter cylindrical part 101B. The extension part 116B is formed at only one location in the small diameter cylindrical part 101B. A distal end surface of the extension part 116B on a side opposite to the contact part 102 in the axial direction of the small diameter cylindrical part 101B has a planar shape that is not perpendicular to a central axis of the small diameter cylindrical part 101B.

Similarly to the spring receiving member 91, the spring receiving member 91B fits into a second large diameter part 43 of a first cylindrical part 31 at the small diameter cylindrical part 101B of the cylindrical part 92B and fits into a contact ring 81 (see FIG. 1) attached to a cylinder 21 at a large diameter cylindrical part 103 to be in contact with an end surface of the contact ring 81 on an opening 24 (see FIG. 1) side in the axial direction at the contact part 102.

In this state, the spring receiving member 91B is configured such that the notch part 111B provided in the cylindrical part 92B allows an outer circumferential surface side of the second large diameter part 43 of the cylinder 21 and an outer circumferential surface side of the small diameter cylindrical part 101B of the cylindrical part 92B to communicate with each other.

In this state, as shown in FIG. 5, a band member 131 is disposed to overlap one extension part 116B and one notch part 111B of the spring receiving member 91B in position in the axial direction of the small diameter cylindrical part 101B, and is wound around an outer surface of the one extension part 116B on an outer side in a radial direction of the small diameter cylindrical part 101B. Thereafter, the band member 131 is tightened. Then, at least a part of an inner circumferential surface of the band member 131 is in contact with an outer circumferential surface of the cylindrical part 92B and an outer circumferential surface of the cylinder 21, and is in a state of having a surface facing the cylindrical part 92B and a surface facing the cylinder 21. Specifically, the band member 131 faces the outer surface of the one extension part 116B on an outer side in the radial direction of the small diameter cylindrical part 101B at a part of serrations (not shown) on an inner circumferential surface of a strip-shaped part 132, and is brought into contact with and pressed against the outer surface. At the same time, the strip-shaped part 132 of the band member 131 enters the inside of a space formed by the notch part 111B of the small diameter cylindrical part 101B and faces the outer circumferential surface of the second large diameter part 43 of the cylinder 21 at a part of the serrations (not shown) on the inner circumferential surface thereof to be in contact with and pressed against the outer circumferential surface.

Thereby, the band member 131, the spring receiving member 91B, and the cylinder 21 are in a fixed state due to a frictional force of the strip-shaped part 132. In other words, due to the band member 131, movement of the spring receiving member 91B to both sides in a circumferential direction of the cylinder 21 with respect to the cylinder 21 is suppressed, and movement thereof to both sides in an axial direction of the cylinder 21 with respect to the cylinder 21 is suppressed. In other words, the band member 131 is in contact with the outer circumferential surface of the cylinder 21 and the cylindrical part 92B to suppress circumferential relative movement and axial relative movement between the cylinder 21 and the spring receiving member 91B. Further, movement of the spring receiving member 91B to a bottom part 23 (see FIG. 1) side in the axial direction of the cylinder 21 with respect to the cylinder 21 is restricted by the contact ring 81 (see FIG. 1).

In the shock absorber 11B of the third embodiment, the band member 131 is in contact with the outer circumferential surface of the cylinder 21 and the cylinder-shaped cylindrical part 92B of the spring receiving member 91B that covers at least a part of the cylinder 21 to suppress relative movement in the circumferential direction between the cylinder 21 and the spring receiving member 91B. In this way, in the shock absorber 11B, since the band member 131 is in contact with the outer circumferential surface of the cylinder 21 and the cylindrical part 92B of the spring receiving member 91B, due to a frictional force thereof, relative movement in the circumferential direction between the cylinder 21 and the spring receiving member 91B can be effectively suppressed. Also, in the shock absorber 11B, since the band member 131 is in contact with the outer circumferential surface of the cylinder 21 and the cylindrical part 92B of the spring receiving member 91B, due to the frictional force thereof, relative movement in the axial direction between the cylinder 21 and the spring receiving member 91B can also be effectively suppressed. That is, in the shock absorber 11B, the band member 131 suppresses axial movement of the spring receiving member 91B in a direction opposite to the bottom part 23 (see FIG. 1) with respect to the cylinder 21, which is not restricted by the contact ring 81 (see FIG. 1), in addition to axial movement of the spring receiving member 91B in a direction of the bottom part 23 with respect to the cylinder 21, which is restricted by the contact ring 81. Therefore, in the shock absorber 11B, relative movement between the cylinder 21 and the spring receiving member 91B can be effectively suppressed. As a matter of course, in the shock absorber 11B, since the band member 131 only needs to be in contact with the outer circumferential surface of the cylinder 21 and the cylindrical part 92B of the spring receiving member 91B, deformation occurring in the cylinder 21 can be suppressed.

Also, the shock absorber 11B includes the notch part 111B provided in the cylindrical part 92B of the spring receiving member 91B to allow communication between the outer circumferential surface side of the cylinder 21 and the outer circumferential surface side of the cylindrical part 92B. Therefore, in the shock absorber 11B, the band member 131 can be easily brought into contact with the outer circumferential surface of the cylinder 21 and the outer circumferential surface of the cylindrical part 92B.

Also, in the shock absorber 11B, since the notch part 111B is formed so that at least a part of an axial length of the cylindrical part 92B is reduced, a configuration for the band member 131 to pass through the cylindrical part 92B in the radial direction can be easily formed.

### Fourth Embodiment

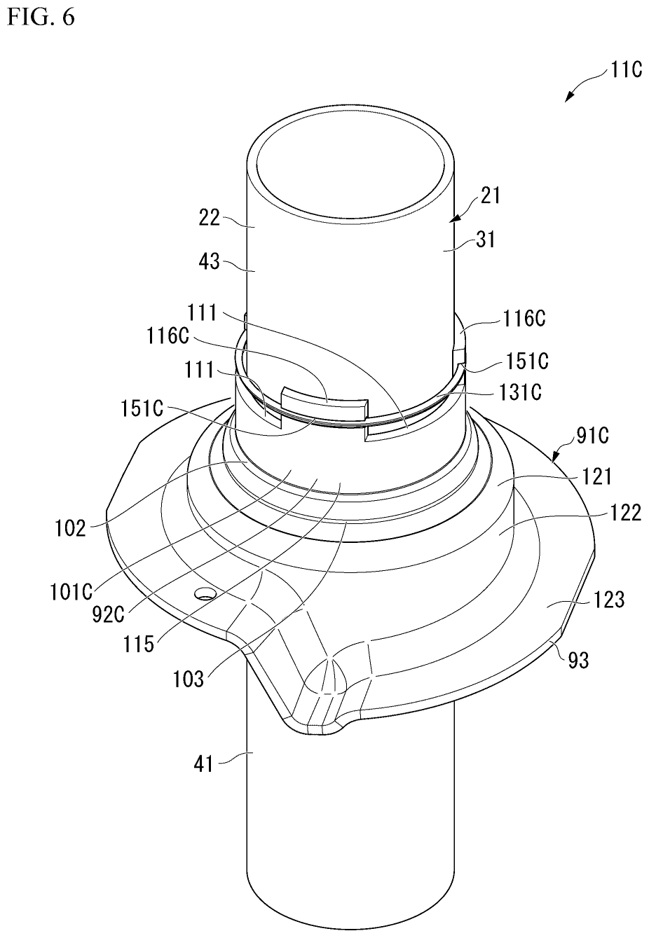

Next, a fourth embodiment will be described mainly on the basis of FIG. 6, focusing on differences from the first embodiment. Further, parts common to those in the first embodiment will be denoted by the same terms and the same reference signs.

As shown in FIG. 6, a shock absorber 11C of the fourth embodiment includes a spring receiving member 91C, which is partially different from the spring receiving member 91, instead of the spring receiving member 91. The spring receiving member 91C has a cylindrical part 92C, which is partially different from the cylindrical part 92, instead of the cylindrical part 92. The cylindrical part 92C has a small diameter cylindrical part 101C, which is partially different from the small diameter cylindrical part 101, instead of the small diameter cylindrical part 101. The small diameter cylindrical part 101C is different from the small diameter cylindrical part 101 in that it has an extension part 116C, which is partially different from the extension part 116, instead of the extension part 116.

A plurality of, specifically three, extension parts 116C having the same shape each have an engagement groove 151C, which is recessed inward in a radial direction of the small diameter cylindrical part 101C, formed on an outer surface of the small diameter cylindrical part 101C on an outer side in the radial direction. The extension part 116C is different from the extension part 116 in this point. The plurality of engagement grooves 151C respectively penetrate the extension parts 116C in a circumferential direction of the small diameter cylindrical part 101C. All the engagement grooves 151C of the small diameter cylindrical part 101C are disposed on the same circle. All the engagement grooves 151C of the small diameter cylindrical part 101C are configured such that groove bottom surfaces on a back side in a recess direction are disposed on the same cylindrical surface.

The shock absorber 11C includes a ring member 131C (second movement suppression part), which is different from the band member 131, instead of the band member 131. The ring member 131C is endless, that is, formed in an annular shape. The ring member 131C is an integrally molded product made of one member formed of an elastically deformable rubber material. The ring member 131C is specifically a square ring.

Similarly to the spring receiving member 91, the spring receiving member 91C fits into a second large diameter part 43 of a first cylindrical part 31 at the small diameter cylindrical part 101C of the cylindrical part 92C and fits into a contact ring 81 (see FIG. 1) attached to a cylinder 21 at a large diameter cylindrical part 103 to be in contact with an end surface of the contact ring 81 on an opening 24 (see FIG. 1) side in the axial direction at a contact part 102.

In this state, as shown in FIG. 6, the ring member 131C, in a state of being extended in a circumferential direction as a whole and increased in diameter, is disposed to overlap all the engagement grooves 151C of the plurality of extension parts 116C and a plurality of groove parts 111 of the spring receiving member 91C in position in an axial direction of the small diameter cylindrical part 101C, and faces outer surfaces of the plurality of extension parts 116C on an outer side in the radial direction of the small diameter cylindrical part 101C. Then, the increased diameter state of the ring member 131C is released. Then, the ring member 131C enters and engages with the plurality of engagement grooves 151C due to a reduction in diameter, and at least a part of an inner circumferential surface thereof is in contact with the groove bottom surfaces of the engagement grooves 151C, which are a part of an outer circumferential surface of the cylindrical part 92C, and the outer circumferential surface of the cylinder 21 to be in a state of having surfaces facing the cylindrical part 92C and surfaces facing the cylinder 21. Specifically, the band member 131C faces the groove bottom surfaces of the plurality of engagement grooves 151C, which are outer surfaces of the plurality of the extension parts 116C on an outer side in the radial direction of the small diameter cylindrical part 101C, at a part of the inner circumferential surface thereof, and is brought into contact with and pressed against the groove bottom surfaces. At the same time, the ring member 131C enters the inside of the plurality of groove parts 111 and faces an outer circumferential surface of the second large diameter part 43 of the cylinder 21 at a part of the inner circumferential surface thereof to be in contact with and pressed against the outer circumferential surface. The ring member 131C is in contact with and pressed against the groove bottom surfaces of the plurality of engagement grooves 151C at a plurality of regions spaced apart in the circumferential direction. At the same time, the ring member 131C is in contact with and pressed against the outer circumferential surface of the second large diameter part 43 at the plurality of regions spaced apart in the circumferential direction.

Thereby, the ring member 131C, the spring receiving member 91C, and the cylinder 21 are in a fixed state due to a frictional force of the ring member 131C. In other words, due to the ring member 131C, movement of the spring receiving member 91C to both sides in a circumferential direction of the cylinder 21 with respect to the cylinder 21 is suppressed, and movement thereof to both sides in an axial direction of the cylinder 21 with respect to the cylinder 21 is suppressed. In other words, the ring member 131C is in contact with the outer circumferential surface of the cylinder 21 and the cylindrical part 92C to suppress circumferential relative movement and axial relative movement between the cylinder 21 and the spring receiving member 91C. Further, movement of the spring receiving member 91C to a bottom part 23 (see FIG. 1) side in the axial direction of the cylinder 21 with respect to the cylinder 21 is restricted by the contact ring 81 (see FIG. 1).

In the shock absorber 11C of the fourth embodiment, the band member 131C is in contact with the outer circumferential surface of the cylinder 21 and the cylinder-shaped cylindrical part 92C of the spring receiving member 91C that covers at least a part of the cylinder 21 to suppress relative movement in the circumferential direction between the cylinder 21 and the spring receiving member 91C. In this way, in the shock absorber 11C, since the band member 131C is in contact with the outer circumferential surface of the cylinder 21 and the cylindrical part 92C of the spring receiving member 91C, due to a frictional force thereof, relative movement in the circumferential direction between the cylinder 21 and the spring receiving member 91C can be effectively suppressed. Also, in the shock absorber 11C, since the band member 131C is in contact with the outer circumferential surface of the cylinder 21 and the cylindrical part 92C of the spring receiving member 91C, due to the frictional force thereof, relative movement in the axial direction between the cylinder 21 and the spring receiving member 91C can also be effectively suppressed. That is, in the shock absorber 11C, the band member 131C suppresses axial movement of the spring receiving member 91C in a direction opposite to the bottom part 23 (see FIG. 1) with respect to the cylinder 21, which is not restricted by the contact ring 81 (see FIG. 1), in addition to axial movement of the spring receiving member 91C in a direction of the bottom part 23 with respect to the cylinder 21, which is restricted by the contact ring 81. Therefore, in the shock absorber 11C, relative movement between the cylinder 21 and the spring receiving member 91C can be effectively suppressed. As a matter of course, in the shock absorber 11C, since the band member 131C only needs to be in contact with the outer circumferential surface of the cylinder 21 and the cylindrical part 92C of the spring receiving member 91C, deformation occurring in the cylinder 21 can be suppressed.

Also, since the shock absorber 11C uses the band member 131C formed in an annular shape from a rubber material, the band member 131C can be easily attached to be in contact with the outer circumferential surface of the cylinder 21 and the cylinder-shaped cylindrical part 92C of the spring receiving member 91C. Moreover, the shock absorber 11C can suppress an increase in weight due to the band member 131C, and thus can suppress an increase in component costs.

### Fifth Embodiment

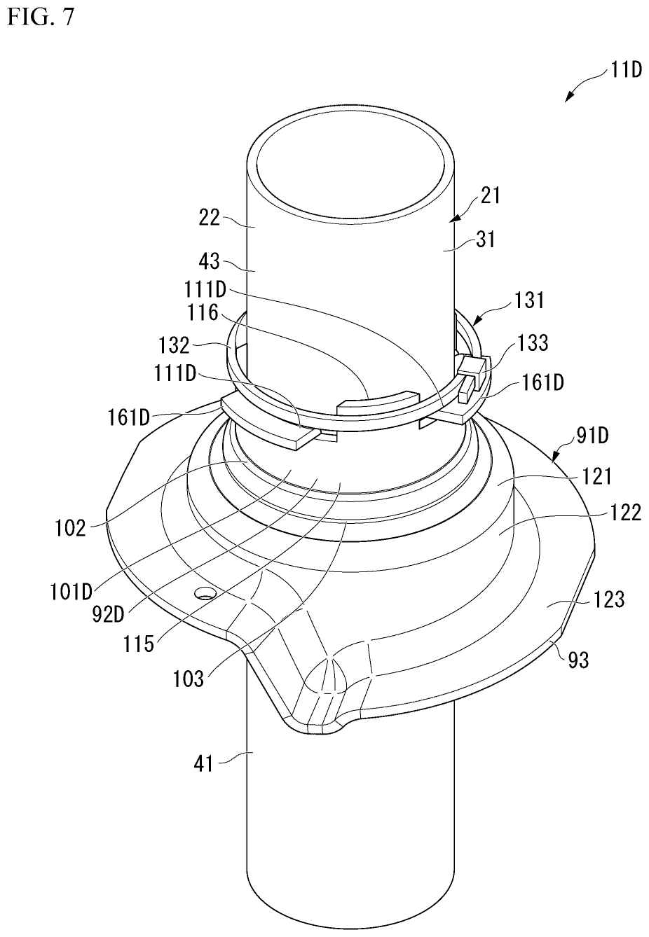

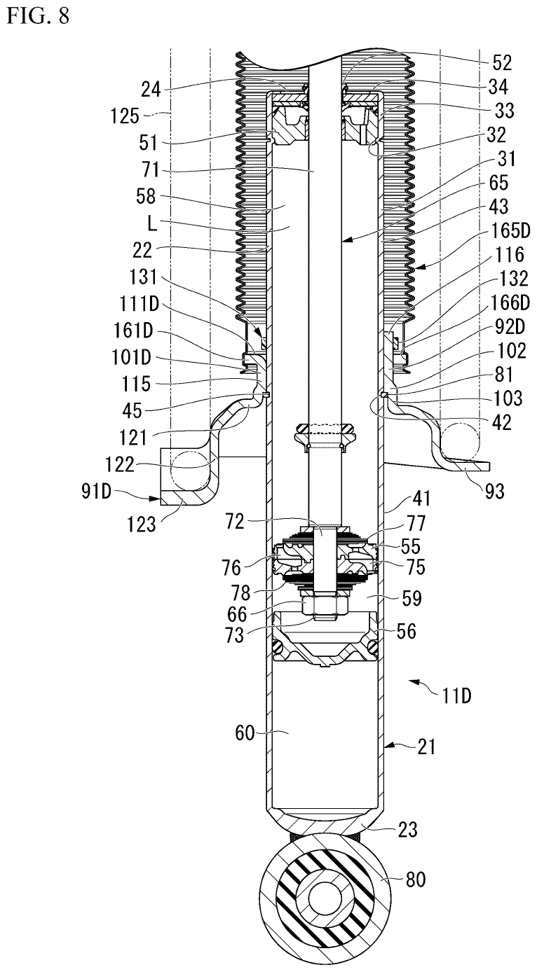

Next, a fifth embodiment will be described mainly on the basis of FIGS. 7 and 8, focusing on differences from the first embodiment. Further, parts common to those in the first embodiment will be denoted by the same terms and the same reference signs.

As shown in FIG. 7, a shock absorber 11D of the fifth embodiment includes a spring receiving member 91D, which is partially different from the spring receiving member 91, instead of the spring receiving member 91. The spring receiving member 91D has a cylindrical part 92D, which is partially different from the cylindrical part 92, instead of the cylindrical part 92. The cylindrical part 92D has a small diameter cylindrical part 101D, which is partially different from the small diameter cylindrical part 101, instead of the small diameter cylindrical part 101. The small diameter cylindrical part 101D is different from the small diameter cylindrical part 101 in that it has a groove part 111D (communication part), which is partially different from the groove part 111, instead of the groove part 111.

The cylindrical part 92D has a plurality of, specifically three, protruding parts 161D having the same shape. The protruding parts 161D protrude outward in a radial direction of the small diameter cylindrical part 101D from the small diameter cylindrical part 101D.

The plurality of, specifically three, groove parts 111D having the same shape are each configured such that a groove bottom surface (axial end surface) on a bottom part 102 side in an axial direction of the small diameter cylindrical part 101D has a surface of the protruding part 161D on a side opposite to the contact part 102 in the axial direction of the small diameter cylindrical part 101D. In other words, the protruding part 161D protruding outward in a radial direction is formed on the groove bottom surface of the groove part 111D. Other than this, the groove part 111D has substantially the same shape as the groove part 111.

Here, the small diameter cylindrical part 101D has a cylindrical shape over the entire length in an uncompleted state thereof. A notch is made at a distal end portion of the small diameter cylindrical part 101D in this state to form both side surfaces of the groove part 111D, and the protruding part 161D and the groove part 111D are formed by tilting a portion between both the side surfaces outward in the radial direction of the small diameter cylindrical part 101D. The plurality of protruding parts 161D are disposed on the same plane, and then processed appropriately to have a shape in which distal end surfaces on a protruding side are disposed on the same cylindrical surface. Therefore, the spring receiving member 91D is an integrally molded product made of a single member of a metal including all the protruding parts 161D.

In the shock absorber 11D of the fifth embodiment, similarly to the shock absorber 11, the spring receiving member 91 and a cylinder 21 are in a fixed state due to a band member 131. At that time, a strip-shaped part 132 of the band member 131 enters the inside of the plurality of groove parts 111D of the small diameter cylindrical part 101D to be in contact with and pressed against an outer circumferential surface of a second large diameter part 43 of the cylinder 21.

Thereafter, the shock absorber 11D is assembled to a vehicle side. At that time, as shown in FIG. 8, a dust cover 165D that covers at least a part of the cylinder 21 or at least a part of the cylindrical part 92D from radially outer side thereof is provided on a radially outer side of the shock absorber 11D. Specially, the dust cover 165D covers a range from an end portion of the second large diameter part 43 of a first cylindrical part 31 of the cylinder 21 on an intermediate locking part 32 side in the axial direction to an intermediate predetermined position, the intermediate locking part 32, a second cylindrical part 33, and an end portion locking part 34. Also, the dust cover 165D covers a range from an end portion of the small diameter cylindrical part 101D of the spring receiving member 91D on a side opposite side to the contact part 102 in the axial direction to a predetermined position on the contact part 102 side with respect to the protruding part 161D. Therefore, the dust cover 165D also covers the band member 131 on an outer side in the radial direction. In other words, the band member 131 is disposed in the dust cover 165D within the range in the axial direction on a radially inner side. The dust cover 165D is disposed between a suspension spring 125 and the shock absorber 11D in the radial direction.

The dust cover 165D is formed in a bellows cylindrical shape from a synthetic resin, and extends and contracts in an axial direction thereof. The dust cover 165D has an engagement recessed part 166D, which is recessed from the inside to the outside in the radial direction, formed at one end in the axial direction. The engagement recessed part 166D has an annular shape.

In a state in which the dust cover 165D covers at least a part of the cylinder 21 and at least a part of the cylindrical part 92D as described above, the engagement recessed part 166D positioned at an end portion of the dust cover 165D on the spring receiving member 91D side in the axial direction engages with the plurality of protruding parts 161D of the spring receiving member 91D. Thereby, axial movement and radial movement of the engagement recessed part 166D, which is at least a part of the dust cover 165D, with respect to the spring receiving member 91D and the cylinder 21 are suppressed by the protruding part 161D. When the dust cover 165D is assembled to the vehicle together with the shock absorber 11D and the suspension spring 125, axial movement and radial movement of the engagement recessed part 166D with respect to the spring receiving member 91D and the cylinder 21 are suppressed by the protruding part 161D.

The shock absorber 11D of the fifth embodiment achieves the same effects as the shock absorber 11.

In addition, in the shock absorber 11D, axial movement of at least a part of the dust cover 165D, which covers at least a part of the cylinder 21 or at least a part of the cylindrical part 92D, with respect to the cylinder 21 is suppressed by the protruding part 161D of the spring receiving member 91D. Therefore, the shock absorber 11D does not require a dedicated component for suppressing axial movement of at least a part of the dust cover 165D with respect to the cylinder 21. Therefore, the shock absorber 11D can reduce the number of components and costs.

### Sixth Embodiment

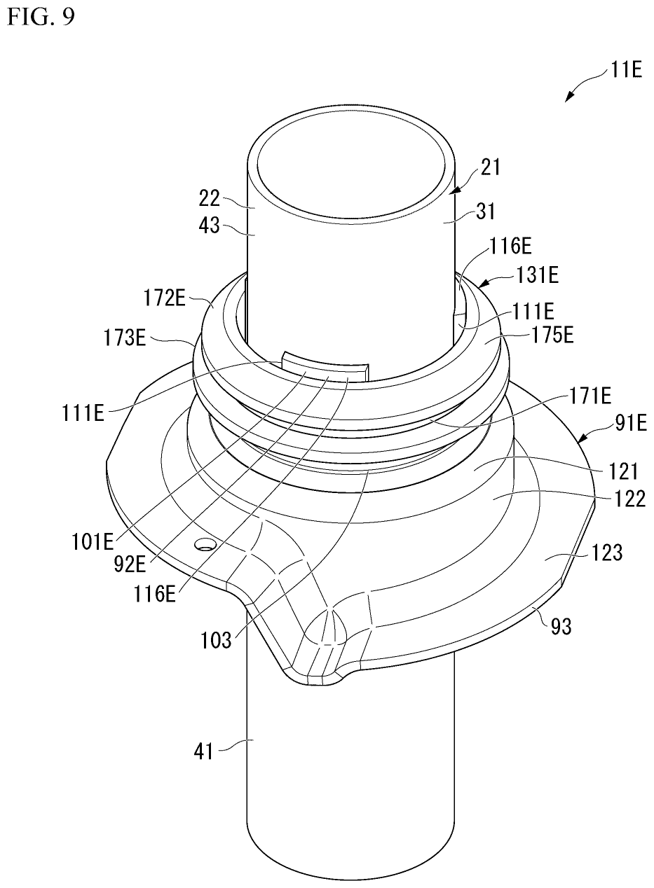

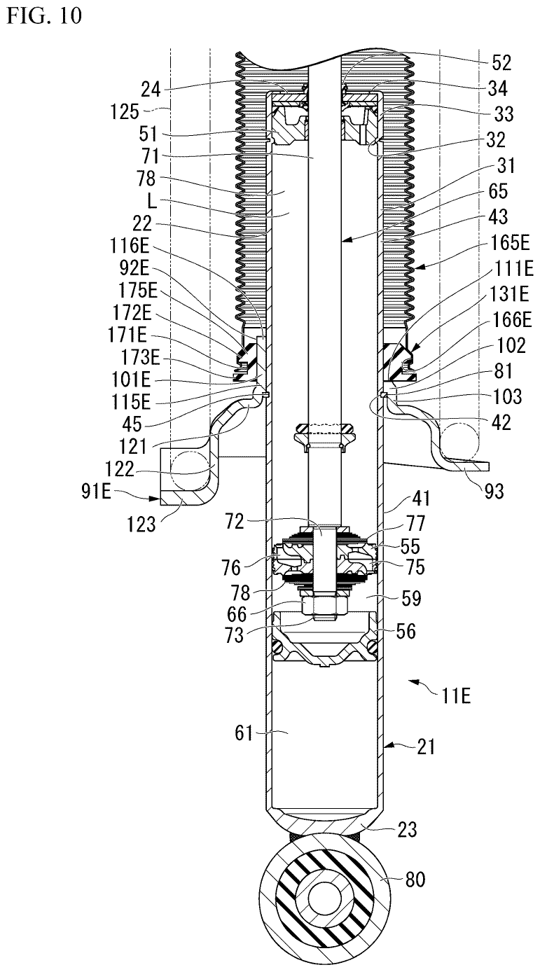

Next, a sixth embodiment will be described mainly on the basis of FIGS. 9 and 10, focusing on differences from the first embodiment. Further, parts common to those in the first embodiment will be denoted by the same terms and the same reference signs.

As shown in FIG. 9, a shock absorber 11E of the sixth embodiment includes a spring receiving member 91E, which is partially different from the spring receiving member 91, instead of the spring receiving member 91. The spring receiving member 91E has a cylindrical part 92E, which is partially different from the cylindrical part 92, instead of the cylindrical part 92. The cylindrical part 92E has a small diameter cylindrical part 101E, which is partially different from the small diameter cylindrical part 101, instead of the small diameter cylindrical part 101. As shown in FIG. 10, the small diameter cylindrical part 101E has a groove part 111E (communication part), which has substantially the same shape as the groove part 111 and has a larger depth in an axial direction of the small diameter cylindrical part 101E than the groove part 111, instead of the groove part 111. Thereby, the small diameter cylindrical part 101E has a base part 115E, which has substantially the same shape as the base part 115 and has a smaller length in the axial direction than the base part 115, instead of the base part 115. Also, the small diameter cylindrical part 101E has a plurality of extension parts 116E, each of which has substantially the same shape as the extension part 116 and has a larger length in the axial direction of the small diameter cylindrical part 101E than the extension part 116, instead of the plurality of extension parts 116.

As shown in FIG. 9, the shock absorber 11E includes a ring member 131E (second movement suppression part), which is different from the band member 131, instead of the band member 131. The ring member 131E is endless, that is, formed in an annular shape. The ring member 131E is an integrally molded product made of one member formed of an elastically deformable rubber material.

The ring member 131E includes an accommodation groove 171E, which is recessed radially inward from an outer circumferential surface, formed at an intermediate portion in an axial direction thereof. The accommodation groove 171E has an annular shape. Thereby, one side of the ring member 131E with respect to the accommodation groove 171E in the axial direction is an engagement flange part 172E protruding radially outward from a groove bottom surface of the accommodation groove 171E, and the other side thereof with respect to the accommodation groove 171E in the axial direction is a flange part 173E protruding radially outward from the groove bottom surface of the accommodation groove 171E. Both the engagement flange part 172E and the flange part 173E are annular. An outer circumferential portion of an end portion of the engagement flange part 172E on a side opposite to the flange part 173E in the axial direction is chamfered. The engagement flange part 172E and the accommodation groove 171E form a stepped part 175E formed so that a part of an outer circumferential surface of the ring member 131E is stepped.

As shown in FIG. 10, similarly to the spring receiving member 91, the spring receiving member 91E fits into a second large diameter part 43 of a first cylindrical part 31 at the small diameter cylindrical part 101E of the cylindrical part 92E and fits into a contact ring 81 attached to a cylinder 21 at a large diameter cylindrical part 103 to be in contact with an end surface of the contact ring 81 on an opening 24 side in the axial direction at a contact part 102.

In this state, the ring member 131E, in a state of being increased in diameter as a whole, is disposed to overlap the plurality of extension parts 116E and a plurality of groove parts 111E of the spring receiving member 91E in position in the axial direction of the small diameter cylindrical part 101E, and faces outer surfaces of the plurality of extension parts 116E on an outer side in a radial direction of the small diameter cylindrical part 101E as shown in FIG. 9. At that time, the ring member 131E is directed such that the flange part 173E is positioned on the contact part 102 side with respect to the engagement flange part 172E in the axial direction of the small diameter cylindrical part 101E. Thereafter, the increased diameter state of the ring member 131E is released. Then, the ring member 131E is reduced in diameter, and at least a part of an inner circumferential surface thereof is in contact with an outer circumferential surface of the cylindrical part 92E and an outer circumferential surface of the cylinder 21 to be in a state of having a surface facing the cylindrical part 92E and a surface facing the cylinder 21. Specifically, the ring member 131E, at a part of the inner circumferential surface thereof, faces outer surfaces of the plurality of extension parts 116E on an outer side in the radial direction of the small diameter cylindrical part 101E, and is brought into contact with and pressed against the outer surfaces thereof. At the same time, the ring member 131E enters the inside of the plurality of groove parts 111E and faces an outer circumferential surface of the second large diameter part 43 of the cylinder 21 at a part of the inner circumferential surface thereof to be in contact with and pressed against the outer circumferential surface. The ring member 131E is in contact with and pressed against the outer surfaces of the plurality of extension parts 116E on an outer side in the radial direction of the small diameter cylindrical part 101E at a plurality of regions spaced apart in the circumferential direction. At the same time, the ring member 131E is in contact with and pressed against the outer circumferential surface of the second large diameter part 43 at the plurality of regions spaced apart in the circumferential direction.

Thereby, the ring member 131E, the spring receiving member 91E, and the cylinder 21 are in a fixed state due to a frictional force of the ring member 131E. In other words, due to the ring member 131E, movement of the spring receiving member 91E to both sides in a circumferential direction of the cylinder 21 with respect to the cylinder 21 is suppressed, and movement thereof to both sides in an axial direction of the cylinder 21 with respect to the cylinder 21 is suppressed. In other words, the ring member 131E is in contact with the outer circumferential surface of the cylinder 21 and the cylindrical part 92E to suppress circumferential relative movement and axial relative movement between the cylinder 21 and the spring receiving member 91E.

Thereafter, the shock absorber 11E is assembled to a vehicle side. At that time, as shown in FIG. 10, a dust cover 165E that covers at least a part of the cylinder 21 or at least a part of the cylindrical part 92E from radially outer side thereof is provided on a radially outer side of the shock absorber 11E. Specially, the dust cover 165E covers a range from an end portion of the second large diameter part 43 of the first cylindrical part 31 of the cylinder 21 on an intermediate locking part 32 side in the axial direction to an intermediate predetermined position, the intermediate locking part 32, a second cylindrical part 33, and an end portion locking part 34. Also, the dust cover 165E covers a range from an end portion of the small diameter cylindrical part 101E of the spring receiving member 91E on a side opposite side to the contact part 102 in the axial direction to a predetermined position on the end portion side with respect to the groove bottom surface of the groove part 111E. The dust cover 165E is disposed between a suspension spring 125 and the shock absorber 11E in the radial direction.

The dust cover 165E is formed in a bellows cylindrical shape from a synthetic resin, and extends and contracts in an axial direction thereof. The dust cover 165E has an engagement recessed part 166E, which is recessed from the inside to the outside in the radial direction, formed at one end in the axial direction thereof. The engagement recessed part 166E has an annular shape.

In a state in which the dust cover 165E covers at least a part of the cylinder 21 and at least a part of the cylindrical part 92E as described above, the engagement recessed part 166E positioned at an end portion of the dust cover 165E on the spring receiving member 91E side in the axial direction engages with the engagement flange part 172E of the stepped part 175E of the ring member 131E. Thereby, axial movement and radial movement of the engagement recessed part 166E, which is at least a part of the dust cover 165E, with respect to the spring receiving member 91E and the cylinder 21 are suppressed by the engagement flange part 172E.

In the shock absorber 11E of the sixth embodiment, the ring member 131E is in contact with the outer circumferential surface of the cylinder 21 and the cylinder-shaped cylindrical part 92E of the spring receiving member 91E that covers at least a part of the cylinder 21 to suppress relative movement in the circumferential direction between the cylinder 21 and the spring receiving member 91E. In this way, in the shock absorber 11E, since the ring member 131E is in contact with the outer circumferential surface of the cylinder 21 and the cylindrical part 92E of the spring receiving member 91E, due to a frictional force thereof, relative movement in the circumferential direction between the cylinder 21 and the spring receiving member 91E can be effectively suppressed. Also, in the shock absorber 11E, since the ring member 131E is in contact with the outer circumferential surface of the cylinder 21 and the cylindrical part 92E of the spring receiving member 91E, due to the frictional force thereof, relative movement in the axial direction between the cylinder 21 and the spring receiving member 91E can also be effectively suppressed. That is, in the shock absorber 11E, the ring member 131E suppresses axial movement of the spring receiving member 91E in a direction opposite to the bottom part 23 with respect to the cylinder 21, which is not restricted by the contact ring 81, in addition to axial movement of the spring receiving member 91E in a direction of the bottom part 23 with respect to the cylinder 21, which is restricted by the contact ring 81. Therefore, in the shock absorber 11E, relative movement between the cylinder 21 and the spring receiving member 91E can be effectively suppressed. As a matter of course, in the shock absorber 11E, since the ring member 131E only needs to be in contact with the outer circumferential surface of the cylinder 21 and the cylindrical part 92E of the spring receiving member 91E, deformation occurring in the cylinder 21 can be suppressed.

Also, since the shock absorber 11E uses the ring member 131E formed in an annular shape from a rubber material, the ring member 131E can be easily attached to be in contact with the outer circumferential surface of the cylinder 21 and the cylinder-shaped cylindrical part 92E of the spring receiving member 91E. Moreover, the shock absorber 11E can suppress an increase in weight due to the ring member 131E, and thus can suppress an increase in component costs.

In addition, in the shock absorber 11E, axial movement of at least a part of the dust cover 165E, which covers at least a part of the cylinder 21 or at least a part of the cylindrical part 92E, with respect to the cylinder 21 is suppressed by the stepped part 175E of the ring member 131E. Therefore, the shock absorber 11E does not require a dedicated component for suppressing axial movement of at least a part of the dust cover 165E with respect to the cylinder 21. Therefore, the shock absorber 11E can reduce the number of components and costs.

### Seventh Embodiment

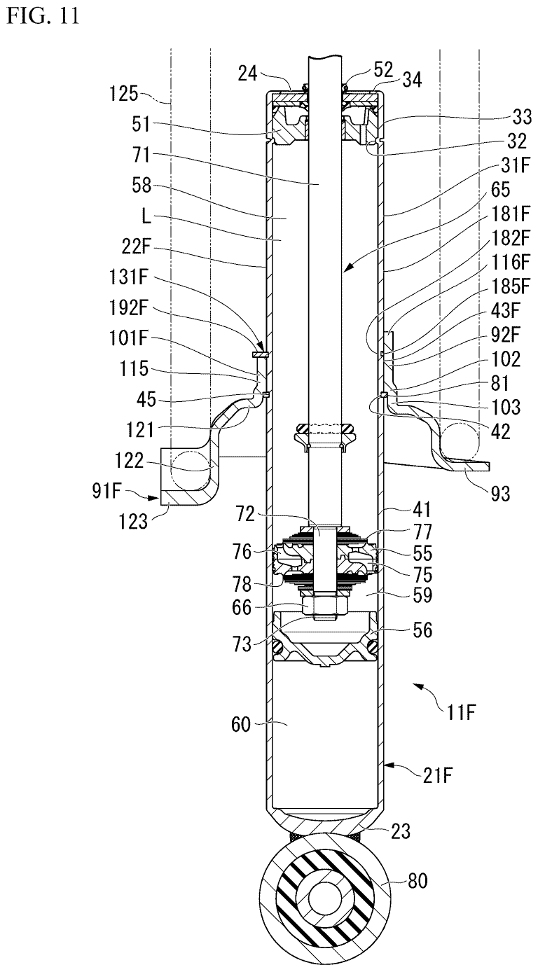

Next, a seventh embodiment will be described mainly on the basis of FIGS. 11 to 13, focusing on differences from the first embodiment. Further, parts common to those in the first embodiment will be denoted by the same terms and the same reference signs.

As shown in FIG. 11, a shock absorber 11F of the seventh embodiment includes a cylinder 21F, which is partially different from the cylinder 21, instead of the cylinder 21. The cylinder 21F has a barrel part 22F, which is partially different from the barrel part 22, instead of the barrel part 22. The barrel part 22F has a first cylindrical part 31F (cylindrical part), which is partially different from the first cylindrical part 31, instead of the first cylindrical part 31. The first cylindrical part 31F includes a second large diameter part 43F which is partially different from the second large diameter part 43, a third large diameter part 181F which is partially different from the second large diameter part 43, and a second small diameter part 182F, instead of the second large diameter part 43.

The first cylindrical part 31F has a cylindrical shape over the entire axial length thereof, and includes a first large diameter part 41, a small diameter part 42, the second large diameter part 43F, the second small diameter part 182F, and the third large diameter part 181F in order from a bottom part 23 side in an axial direction thereof.

The second large diameter part 43F has substantially the same shape as the second large diameter part 43, and has a smaller axial length than the second large diameter part 43.

The third large diameter part 181F also has substantially the same shape as the second large diameter part 43, and has a smaller axial length than the second large diameter part 43.

An outer circumferential surface of the second small diameter part 182F on a radially outer side has a cylindrical surface shape, and an inner circumferential surface thereof on a radially inner side has a cylindrical surface shape that is coaxial with the outer circumferential surface. The second small diameter part 182F has an inner diameter equivalent to an inner diameter of the first large diameter part 41, the small diameter part 42, the second large diameter part 43F, and the third large diameter part 181F, and has an outer diameter smaller than an outer diameter of the first large diameter part 41, the second large diameter part 43F, and the third large diameter part 181F.

The first large diameter part 41, the small diameter part 42, the second large diameter part 43F, the second small diameter part 182F, and the third large diameter part 181F have a common central axis.

Therefore, the first cylindrical part 31F has a fitting groove 45 on an outer diameter side of the small diameter part 42 between the first large diameter part 41 and the second large diameter part 43F in the axial direction. The fitting groove 45 is recessed inward in a radial direction from an outer circumferential surface of the first large diameter part 41 and an outer circumferential surface of the second large diameter part 43F. The fitting groove 45 has an annular shape.

Also, the first cylindrical part 31F has a second fitting groove 185F on an outer diameter side of the second small diameter part 182F between the second large diameter part 43F and the third large diameter part 181F in the axial direction. The second fitting groove 185F is recessed inward in the radial direction from the outer circumferential surface of the second large diameter part 43F and an outer circumferential surface of the third large diameter part 181F. The second fitting groove 185F has an annular shape.

The shock absorber 11F includes a spring receiving member 91F, which is partially different from the spring receiving member 91, instead of the spring receiving member 91. The spring receiving member 91F has a cylindrical part 92F, which is partially different from the cylindrical part 92, instead of the cylindrical part 92. The cylindrical part 92F has a small diameter cylindrical part 101F, which is partially different from the small diameter cylindrical part 101, instead of the small diameter cylindrical part 101.

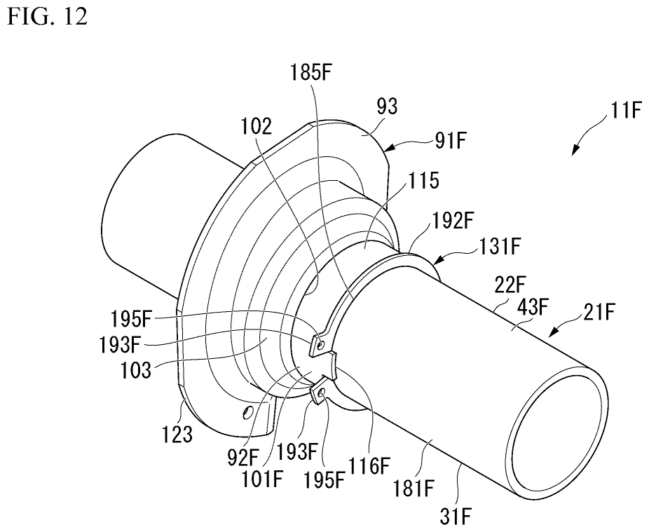

As shown in FIG. 12, the small diameter cylindrical part 101F is different from the small diameter cylindrical part 101 in that it has an axial protruding part 116F instead of the plurality of extension parts 116.

The axial protruding part 116F protrudes in a direction opposite to a contact part 102 from a base part 115 in an axial direction of the small diameter cylindrical part 101F. The small diameter cylindrical part 101F includes the axial protruding part 116F formed at only one location.

The shock absorber 11F includes a ring member 131F (second movement suppression part). The ring member 131F is made of a metal and includes a main body part 192F and a pair of protrusion parts 193F.

The main body part 192F has a C shape formed by dividing a circular ring at one location in the circumferential direction. An outer circumferential surface of the main body part 192F on a radially outer side has a cylindrical surface shape, and an inner circumferential surface thereof on a radially inner side has a cylindrical surface shape that is coaxial with the outer circumferential surface.

The pair of protrusion parts 193F protrude outward in a radial direction of the main body part 192F from both end portions of the main body part 192F on the divided side in the circumferential direction. A thickness of the ring member 131F in an axial direction of the main body part 192F is smaller than a width thereof in the radial direction of the main body part 192F. Engagement holes 195F penetrating in the axial direction of the main body part 192F are formed in the pair of protrusion parts 193F, respectively. The ring member 131F is a snap ring.

As shown in FIG. 11, similarly to the spring receiving member 91, the spring receiving member 91F fits into the second large diameter part 43F of the first cylindrical part 31F at the small diameter cylindrical part 101F of the cylindrical part 92F and fits into a contact ring 81 attached to the cylinder 21F at a large diameter cylindrical part 103 to be in contact with an end surface of the contact ring 81 on an opening 24 side in the axial direction at the contact part 102.

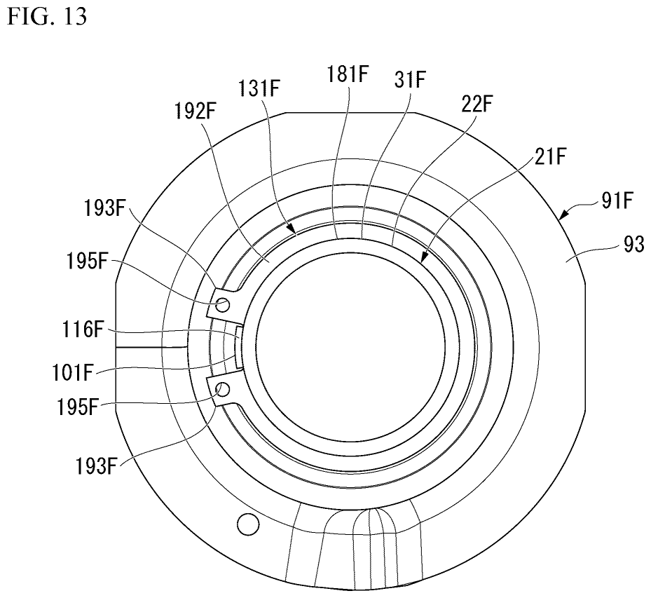

In this state, a side surface of the second fitting groove 185F on the bottom part 23 side in the axial direction of the cylinder 21F is coplanar with an end surface of the base part 115 of the spring receiving member 91F on a side opposite to the contact part 102 in the axial direction. In this state, the ring member 131F is fitted into the second fitting groove 185F of the cylinder 21F. At that time, in the ring member 131F, the axial protruding part 116F of the spring receiving member 91F is disposed between the pair of protrusion parts 193F in the circumferential direction as shown in FIGS. 12 and 13.

An inner diameter of the ring member 131F before fitting into the second fitting groove 185F shown in FIG. 11 is slightly smaller than an outer diameter of the second small diameter part 182F of the cylinder 21F, in other words, a diameter of a groove bottom of the second fitting groove 185F. Therefore, the ring member 131F is in contact with and pressed against a groove bottom surface of the second fitting groove 185F on a back side in a recess direction. Therefore, when the ring member 131F is fitted into the second fitting groove 185F, movement of the ring member 131F to both sides in the circumferential direction with respect to the cylinder 21F is suppressed by a frictional force thereof.

With the ring member 131F fitted into the second fitting groove 185F, an outer diameter of the main body part 192F thereof is larger than an outer diameter of the second large diameter part 43F and the third large diameter part 181F. Therefore, the ring member 131F is provided on the first cylindrical part 31F of the cylinder 21F and protrudes outward in the radial direction from the first cylindrical part 31F of the cylinder 21F.

When the ring member 131F is fitted into the second fitting groove 185F, movement thereof to the bottom part 23 in the axial direction of the cylinder 21F is restricted by coming into contact with an end surface of the second large diameter part 43F on the second small diameter part 182F side in the axial direction. Also, when the ring member 131F is fitted into the second fitting groove 185F, movement thereof to a side opposite to the bottom part 23 in the axial direction of the cylinder 21F is restricted by coming into contact with an end surface of the third large diameter part 181F on the second small diameter part 182F side in the axial direction. Therefore, when the ring member 131F is fitted into the second fitting groove 185F, movement thereof to both sides in the axial direction of the cylinder 21F is suppressed. In addition to these, as described above, the ring member 131F is fixed to the cylinder 21F as a result of the relative movement of the ring member 131F to both sides in the circumferential direction of the cylinder 21F being suppressed by the frictional force thereof.

With the ring member 131F fitted into the second fitting groove 185F, the ring member 131F is in contact with an end surface of the base part 115 of the spring receiving member 91F on a side opposite to the contact part 102 in the axial direction and restricts movement of the spring receiving member 91F to a side opposite to the bottom part 23 in the axial direction of the cylinder 21F.

Also, in this state, as shown in FIGS. 12 and 13, the ring member 131F is disposed such that the main body part 192F thereof is in contact with at least one of both ends of the axial protruding part 116F of the spring receiving member 91F in the circumferential direction of the base part 115 at the end portions on the divided side in the circumferential direction to support the axial protruding part 116F. Thereby, the ring member 131F suppresses relative movement in the circumferential direction between the spring receiving member 91F and the cylinder 21F. Specifically, the main body part 192F of the ring member 131F is in contact with end surfaces on both sides of the axial protruding part 116F of the spring receiving member 91F in the circumferential direction of the base part 115 at both end surfaces on the divided side in the circumferential direction to suppress relative movement to both sides in the circumferential direction between the spring receiving member 91F and the cylinder 21F.

Thereby, movement of the spring receiving member 91F to both sides in the circumferential direction of the cylinder 21F with respect to the cylinder 21F is suppressed by the frictional force of the ring member 131F. At the same time, movement of the spring receiving member 91F to a side opposite to the bottom part 23 in the axial direction of the cylinder 21F with respect to the cylinder 21F is restricted by the ring member 131F. In other words, the ring member 131F is in contact with the groove bottom surface of the second fitting groove 185F constituting the outer circumferential surface of the cylinder 21F and the axial protruding part 116F of the cylindrical part 92F to suppress circumferential relative movement and axial relative movement between the cylinder 21F and the spring receiving member 91F. Further, movement of the spring receiving member 91F to the bottom part 23 side in the axial direction of the cylinder 21F with respect to the cylinder 21F is restricted by the contact ring 81 as described above.

In the shock absorber 11F of the seventh embodiment, the ring member 131F is in contact with the outer circumferential surface of the cylinder 21F and the cylinder-shaped cylindrical part 92F of the spring receiving member 91F that covers at least a part of the cylinder 21F to suppress relative movement in the circumferential direction between the cylinder 21F and the spring receiving member 91F. In this way, in the shock absorber 11F, since the ring member 131F is in contact with the outer circumferential surface of the cylinder 21F and the cylindrical part 92F of the spring receiving member 91F, due to the frictional force thereof, relative movement in the circumferential direction between the cylinder 21F and the spring receiving member 91F can be effectively suppressed. Also, in the shock absorber 11F, since the ring member 131F is in contact with the outer circumferential surface of the cylinder 21F and the axial protruding part 116F of the cylindrical part 92F of the spring receiving member 91F, relative movement in the axial direction between the cylinder 21 and the spring receiving member 91F can also be effectively suppressed. That is, in the shock absorber 11F, the ring member 131F suppresses axial movement of the spring receiving member 91F in a direction opposite to the bottom part 23 with respect to the cylinder 21, which is not restricted by the contact ring 81, in addition to axial movement of the spring receiving member 91F in a direction of the bottom part 23 with respect to the cylinder 21, which is restricted by the contact ring 81. Therefore, in the shock absorber 11F, relative movement between the cylinder 21F and the spring receiving member 91F can be effectively suppressed. As a matter of course, in the shock absorber 11F, since the ring member 131F only needs to be in contact with the outer circumferential surface of the cylinder 21F and the cylindrical part 92F of the spring receiving member 91F, deformation occurring in the cylinder 21F can be suppressed.

Also, in the shock absorber 11F, the spring receiving member 91F has the axial protruding part 116F that protrudes in the axial direction, and the ring member 131F is fixed to the cylinder 21F and is disposed to be in contact with and support at least one of both ends of the axial protruding part 116F in the circumferential direction. Therefore, in the shock absorber 11F, relative movement between the cylinder 21F and the spring receiving member 91F can be easily suppressed by the ring member 131F.

### Eighth Embodiment

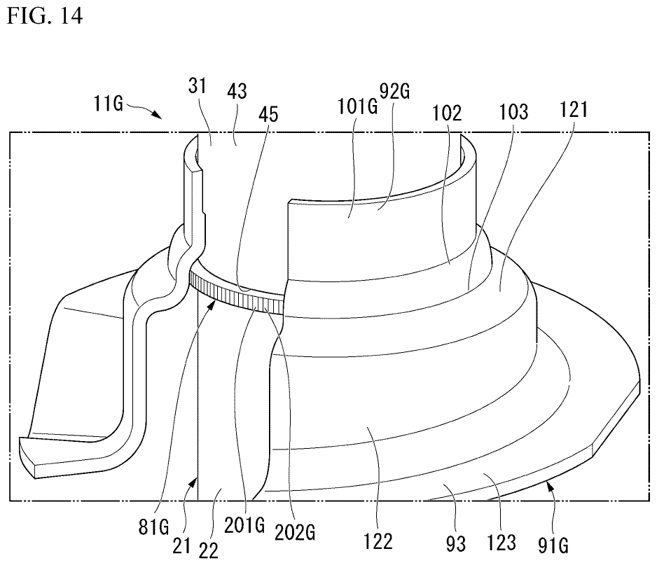

Next, an eighth embodiment will be described mainly on the basis of FIG. 14, focusing on differences from the first embodiment. Further, parts common to those in the first embodiment will be denoted by the same terms and the same reference signs.

As shown in FIG. 14, a shock absorber 11G of the eighth embodiment includes a spring receiving member 91G, which is partially different from the spring receiving member 91, instead of the spring receiving member 91. The spring receiving member 91G has a cylindrical part 92G, which is partially different from the cylindrical part 92, instead of the cylindrical part 92. The cylindrical part 92G has a small diameter cylindrical part 101G, which is partially different from the small diameter cylindrical part 101, instead of the small diameter cylindrical part 101. The small diameter cylindrical part 101G is similar to the base part 115 of the small diameter cylindrical part 101. Therefore, the small diameter cylindrical part 101G has a cylindrical shape over the entire axial length thereof.

The shock absorber 11G includes a contact ring 81G (first movement suppression part), which is partially different from the contact ring 81 (see FIG. 1), instead of the contact ring 81. The contact ring 81G is made of a metal and is a C-shaped C ring formed by dividing a circular ring at one location in the circumferential direction. An outer serration part 202G (second movement suppression part) on which a large number of teeth 201G are disposed in a circumferential direction thereof is formed on an outer circumferential surface of the contact ring 81G on a radially outer side thereof. Also, although not shown in the drawings, an inner serration part (second movement suppression part) on which a large number of teeth are disposed in a circumferential direction thereof is also formed on an inner circumferential surface of the contact ring 81G on a radially inner side thereof. The contact ring 81G is fitted into a fitting groove 45 provided in a first cylindrical part 31 of a cylinder 21. Thereby, the inner serration part of the contact ring 81G is in contact with and pressed against a groove bottom surface of the fitting groove 45.

Similarly to the contact ring 81, with the contact ring 81G fitted into the fitting groove 45, the contact ring 81G protrudes outward in a radial direction from the first cylindrical part 31 of the cylinder 21, and movement thereof to both sides in an axial direction of the cylinder 21 is restricted by the first cylindrical part 31.

Similarly to the spring receiving member 91, the spring receiving member 91G fits into a second large diameter part 43 of the first cylindrical part 31 at the small diameter cylindrical part 101G of the cylindrical part 92G and fits into the contact ring 81G at a large diameter cylindrical part 103 to be in contact with an end surface of the contact ring 81G on an opening 24 (see FIG. 1) side in the axial direction at a contact part 102. At that time, the large diameter cylindrical part 103 is fitted to the contact ring 81G with a slight fastening allowance. Thereby, the outer serration part 202G is in contact with and pressed against a radially inner side of the cylindrical part 92G, and the inner serration part (not shown) is in contact with and pressed against a radially outer side of the cylinder 21.

In the shock absorber 11G of the eighth embodiment, the contact ring 81G is in contact with the groove bottom surface of the fitting groove 45, which is an outer circumferential surface of the cylinder 21, and an inner circumferential surface of the large diameter cylindrical part 103 of the cylinder-shaped cylindrical part 92G of the spring receiving member 91G, which covers at least a part of the cylinder 21, to suppress relative movement in the circumferential direction between the cylinder 21 and the spring receiving member 91G. In this way, in the shock absorber 11G, since the contact ring 81G is in contact with the outer circumferential surface of the cylinder 21 and the inner circumferential surface of the cylindrical part 92G of the spring receiving member 91G, due to a frictional force thereof, relative movement in the circumferential direction between the cylinder 21 and the spring receiving member 91G can be effectively suppressed. Also, in the shock absorber 11G, since the contact ring 81G is in contact with the outer circumferential surface of the cylinder 21 and the inner circumferential surface of the cylindrical part 92G of the spring receiving member 91G, due to the frictional force thereof, relative movement in the axial direction between the cylinder 21 and the spring receiving member 91G can also be effectively suppressed. That is, in the shock absorber 11G, the contact ring 81G restricts axial movement of the spring receiving member 91G in a direction of a bottom part 23 (see FIG. 1) with respect to the cylinder 21, and suppresses axial movement of the spring receiving member 91G in a direction opposite to the bottom part 23 with respect to the cylinder 21. Therefore, in the shock absorber 11G, relative movement between the cylinder 21 and the spring receiving member 91G can be effectively suppressed. As a matter of course, in the shock absorber 11G, since the contact ring 81G only needs to be in contact with the outer circumferential surface of the cylinder 21 and the inner circumferential surface of the cylindrical part 92G of the spring receiving member 91G, deformation occurring in the cylinder 21 can be suppressed.

Also, in the shock absorber 11G, the outer serration part 202G and the inner serration part (not shown) are formed on the radially outer side and the radially inner side of the contact ring 81G, the outer serration part 202G is in contact with the radially inner side of the cylindrical part 92G, and the inner serration part is in contact with the radially outer side of the cylinder 21. Therefore, in the shock absorber 11G, circumferential relative movement and axial relative movement between the cylinder 21 and the spring receiving member 91G can be effectively suppressed with one contact ring 81G.

Further, in the shock absorber 11G, a serration part may be provided in a radially inner portion of the large diameter cylindrical part 103 of the cylindrical part 92G that is in contact with the outer serration part 202G of the contact ring 81G. Also, in the shock absorber 11G, a serration part may be provided at a groove bottom part of the fitting groove 45, which is a radially outer portion of the cylinder 21 in contact with the inner serration part (not shown) of the contact ring 81G. Thereby, a frictional force between the contact ring 81G and the spring receiving member 91G and a frictional force between the contact ring 81G and the cylinder 21 can be further enhanced. Therefore, circumferential relative movement and axial relative movement between the cylinder 21 and the spring receiving member 91G can be suppressed more effectively.

### Ninth Embodiment

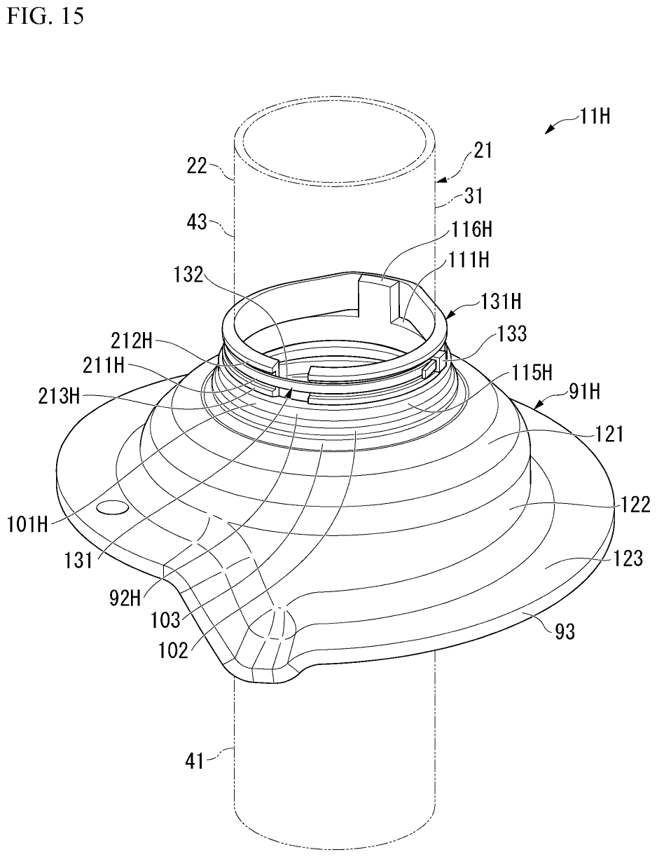

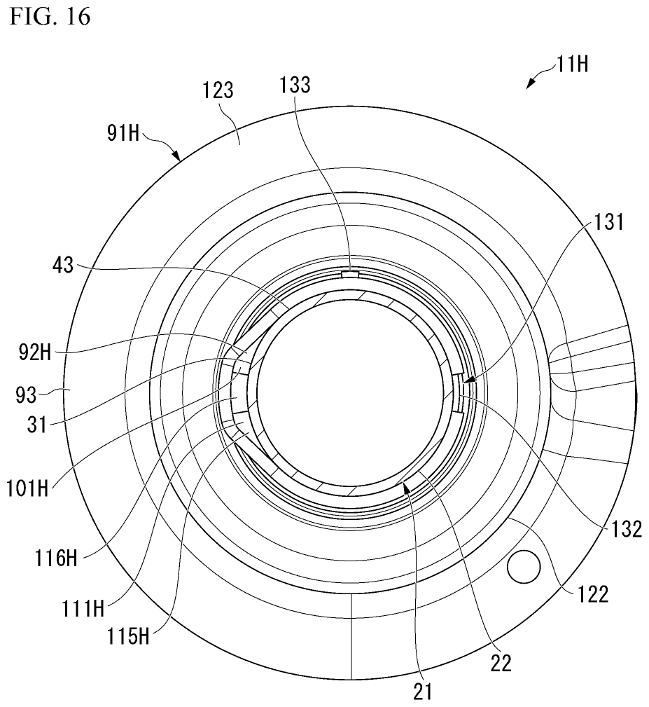

Next, a ninth embodiment will be described mainly on the basis of FIGS. 15 and 16, focusing on differences from the first embodiment. Further, parts common to those in the first embodiment will be denoted by the same terms and the same reference signs.

As shown in FIG. 15, a shock absorber 11H of the ninth embodiment includes a spring receiving member 91H, which is partially different from the spring receiving member 91, instead of the spring receiving member 91. The spring receiving member 91H has a cylindrical part 92H, which is partially different from the cylindrical part 92, instead of the cylindrical part 92. The cylindrical part 92H has a small diameter cylindrical part 101H, which is partially different from the small diameter cylindrical part 101, instead of the small diameter cylindrical part 101.

The small diameter cylindrical part 101H has a notch part 111H (communication part) at a distal end portion on a side opposite to a contact part 102 in an axial direction thereof. The notch part 111H is formed in a notch shape to be recessed from a distal end surface of the small diameter cylindrical part 101H on a side opposite to the contact part 102 in the axial direction to the contact part 102 side in the axial direction of the small diameter cylindrical part 101H. The distal end surface of the small diameter cylindrical part 101H on which the notch part 111H is formed is an end surface of the cylindrical part 92H on a side opposite to the seating part 93 in the axial direction. The notch part 111H penetrates the small diameter cylindrical part 101H in a radial direction from an inner circumferential surface thereof to an outer circumferential surface. The notch part 111H is formed at one location in the small diameter cylindrical part 101H. A groove bottom surface of the notch part 111H on a back side in a recess direction is disposed on the same plane. The notch part 111H is formed so that at least a part of an axial length of the cylindrical part 92H is reduced.

The small diameter cylindrical part 101H includes a base part 115H that is similar to the base part 115 of the small diameter cylindrical part 101 but differs in having a smaller axial length than the base part 115, and an extension part 116H. The extension part 116H extends from the base part 115H to a side opposite to the contact part 102 in an axial direction of the base part 115H. The extension part 116H is formed at one location in the small diameter cylindrical part 101H. A length of the small diameter cylindrical part 101H in the circumferential direction is longer at the notch part 111H than at the extension part 116H.

The shock absorber 11H of the ninth embodiment includes an anti-slip member 131H (second movement suppression part). The anti-slip member 131H has an annular shape and has a shape in which a part in a circumferential direction thereof is cut away. The anti-slip member 131H is an integrally molded product made of one member formed of an elastically deformable rubber material. The anti-slip member 131H has a higher frictional coefficient than the spring receiving member 91H and a cylinder 21.

The anti-slip member 131H includes an accommodation groove 211H, which is recessed radially inward from an outer circumferential surface, formed at an intermediate portion in an axial direction thereof. The accommodation groove 211H has an annular shape and has a shape in which a part in a circumferential direction is cut away. Thereby, in the anti-slip member 131H, one side of the accommodation groove 211H in the axial direction forms a flange part 212H that protrudes outward in the radial direction from a groove bottom surface of the accommodation groove 211H. Also, in the anti-slip member 131H, a side of the accommodation groove 211H opposite to the flange part 212H in the axial direction forms a flange part 213H that protrudes outward in the radial direction from the groove bottom surface of the accommodation groove 211H. Both the flange part 212H and the flange part 213H have an annular shape and have a shape in which a part in a circumferential direction thereof is cut away.

Similarly to the spring receiving member 91, the spring receiving member 91H fits into a second large diameter part 43 of a first cylindrical part 31 of the cylinder 21 at the small diameter cylindrical part 101H of the cylindrical part 92H and fits into a contact ring 81 (see FIG. 1) attached to the cylinder 21 at a large diameter cylindrical part 103 to be in contact with an end surface of the contact ring 81 on an opening 24 (see FIG. 1) side in the axial direction at the contact part 102.

In this state, the spring receiving member 91H is configured such that the notch part 111H provided in the cylindrical part 92H allows communication between an outer circumferential surface side of the second large diameter part 43 of the cylinder 21 and an outer circumferential surface side of the small diameter cylindrical part 101H of the cylindrical part 92H.

In this state, the anti-slip member 131H is disposed to overlap the extension part 116H and the notch part 111H of the spring receiving member 91H in position in the axial direction of the small diameter cylindrical part 101H, and is placed over the second large diameter part 43 of the cylinder 21 and the extension part 116H of the small diameter cylindrical part 101H. Then, the anti-slip member 131H faces an outer surface of the extension part 116H on an outer side in the radial direction of the small diameter cylindrical part 101H and an outer circumferential surface of the second large diameter part 43 of the cylinder 21. In other words, the anti-slip member 131H is in a state of having a surface facing the cylindrical part 92H and a surface facing the cylinder 21.

In this state, a band member 131 is disposed to overlap the accommodation groove 211H of the anti-slip member 131H in position in an axial direction of the anti-slip member 131H, and is wound around the groove bottom surface facing the outside in a radial direction of the accommodation groove 211H. Thereafter, the band member 131 is tightened. Then, in the band member 131, an inner circumferential surface of a strip-shaped part 132 is in contact with the groove bottom surface of the accommodation groove 211H of the anti-slip member 131H, and presses the anti-slip member 131H against the outer circumferential surface of the second large diameter part 43 of the cylinder 21 and an outer surface of the extension part 116H of the spring receiving member 91H on an outer side in the radial direction of the small diameter cylindrical part 101H as shown in FIG. 16. Thereby, the anti-slip member 131H is in a state of being in contact with an outer surface of the cylindrical part 92H and an outer circumferential surface of the cylinder 21. Specifically, a part of the anti-slip member 131H faces the outer surface of the extension part 116H on the outer side in the radial direction of the small diameter cylindrical part 101H, and is brought into contact with and pressed against the outer surface. At the same time, a part of the anti-slip member 131H enters the inside of the notch part 111H of the small diameter cylindrical part 101H and faces the outer circumferential surface of the second large diameter part 43 of the cylinder 21 to be in contact with and pressed against the outer circumferential surface.

As described above, the anti-slip member 131H is in contact with the outer surface of the cylindrical part 92H of the spring receiving member 91H and the outer circumferential surface of the second large diameter part 43 of the cylinder 21, and is in a state of having a surface facing the cylindrical part 92H and a surface facing the second large diameter part 43. Also, the anti-slip member 131H faces the outer surface of the cylindrical part 92H of the spring receiving member 91H, and is brought into contact with and pressed against the outer surface. At the same time, the anti-slip member 131H is in a state of facing the outer circumferential surface of the second large diameter part 43 of the cylinder 21 to be in contact with and pressed against the outer circumferential surface.

The band member 131 is in a state in which the strip-shaped part 132 is fixed to the anti-slip member 131H by a frictional force of the anti-slip member 131H. At the same time, the anti-slip member 131H, the spring receiving member 91H, and the cylinder 21 are in a fixed state due to the frictional force of the anti-slip member 131H. In other words, due to the band member 131 and the anti-slip member 131H, movement of the spring receiving member 91H to both sides in a circumferential direction of the cylinder 21 with respect to the cylinder 21 is suppressed, and movement thereof to both sides in an axial direction of the cylinder 21 with respect to the cylinder 21 is suppressed. In other words, the band member 131 and the anti-slip member 131H are configured such that the anti-slip member 131H is in contact with the outer circumferential surface of the cylinder 21 and the outer surface of the cylindrical part 92H of the extension part 116H on an outer side in the radial direction due to a fastening force of the band member 131 to suppress circumferential relative movement and axial relative movement between the cylinder 21 and the spring receiving member 91H.

Therefore, the band member 131 and the anti-slip member 131H suppress the circumferential and axial relative movement between the cylinder 21 and the spring receiving member 91H by the anti-slip member 131H in contact with the outer circumferential surface of the cylinder 21 and the outer surface of the cylindrical part 92H of the extension part 116H on an outer side in the radial direction. The band member 131 and the anti-slip member 131H include the anti-slip member 131H that is in contact with the cylinder 21 to suppress sliding with respect to the cylinder 21. Further, movement of the spring receiving member 91H to a bottom part 23 (see FIG. 1) side in the axial direction of the cylinder 21 with respect to the cylinder 21 is restricted by the contact ring 81 (see FIG. 1).

In the shock absorber 11H of the ninth embodiment, the anti-slip member 131H of the band member 131 and the anti-slip member 131H is in contact with the outer circumferential surface of the cylinder 21 and the cylinder-shaped cylindrical part 92H of the spring receiving member 91H that covers at least a part of the cylinder 21. Then, in the shock absorber 11H, the band member 131 and the anti-slip member 131H suppress relative movement in the circumferential direction between the cylinder 21 and the spring receiving member 91H. In this way, since the anti-slip member 131H of the band member 131 and the anti-slip member 131H is in contact with the outer circumferential surface of the cylinder 21 and the cylindrical part 92H of the spring receiving member 91H, due to a frictional force thereof, relative movement in the circumferential direction between the cylinder 21 and the spring receiving member 91H can be effectively suppressed. Also, in the shock absorber 11H, since the anti-slip member 131H of the band member 131 and the anti-slip member 131H is in contact with the outer circumferential surface of the cylinder 21 and the cylindrical part 92H of the spring receiving member 91H, due to the frictional force thereof, relative movement in the axial direction between the cylinder 21 and the spring receiving member 91H can also be effectively suppressed. That is, in the shock absorber 11H, the band member 131 and the anti-slip member 131H restrict axial movement of the spring receiving member 91H in a direction opposite to the bottom part 23 (see FIG. 1) with respect to the cylinder 21, which is not restricted by the contact ring 81 (see FIG. 1), in addition to axial movement of the spring receiving member 91H in a direction of the bottom part 23 with respect to the cylinder 21, which is restricted by the contact ring 81. Therefore, in the shock absorber 11H, relative movement between the cylinder 21 and the spring receiving member 91H can be effectively suppressed. As a matter of course, in the shock absorber 11H, since the anti-slip member 131H of the band member 131 and the anti-slip member 131H is in contact with the outer circumferential surface of the cylinder 21 and the cylindrical part 92H of the spring receiving member 91H, and the band member 131 only needs to fasten the anti-slip member 131H, deformation occurring in the cylinder 21 can be suppressed.

Also, the shock absorber 11H includes the notch part 111H provided in the cylindrical part 92H of the spring receiving member 91H to allow communication between the outer circumferential surface side of the cylinder 21 and the outer circumferential surface side of the cylindrical part 92H. Therefore, in the shock absorber 11H, the anti-slip member 131H of the band member 131 and the anti-slip member 131H can be easily brought into contact with the outer circumferential surface of the cylinder 21 and the outer circumferential surface of the cylindrical part 92H.

Also, in the shock absorber 11H, the notch part 111H is formed such that at least a part of the axial length of the cylindrical part 92H is reduced, and specifically, the notch part 111H is formed in a notch shape from an axial end surface of the cylindrical part 92H. Therefore, in the shock absorber 11H, a configuration for the band member 131 and the anti-slip member 131H to pass through the cylindrical part 92H in the radial direction can be easily formed.

Also, since the shock absorber 11H uses the band member 131 formed in a string shape, the band member 131 can be easily attached so that the anti-slip member 131H is brought into contact with the outer circumferential surface of the cylinder 21 and the cylinder-shaped cylindrical part 92H of the spring receiving member 91H.

Also, in the shock absorber 11H, the anti-slip member 131H of the band member 131 and the anti-slip member 131H is in contact with the spring receiving member 91H and the cylinder 21 to suppress sliding of the spring receiving member 91H with respect to the cylinder 21. Therefore, the shock absorber 11H can more effectively suppress relative movement between the cylinder 21 and the spring receiving member 91H.

Also, since the anti-slip member 131H of the band member 131 and the anti-slip member 131H is formed of a rubber material, the shock absorber 11H can more effectively suppress relative movement between the cylinder 21 and the spring receiving member 91H. Also, in the shock absorber 11H, since the anti-slip member 131H is formed of a rubber material, the anti-slip member 131H can be easily attached to be in contact with the outer circumferential surface of the cylinder 21 and the cylindrical part 92H of the spring receiving member 91H. Moreover, in the shock absorber 11H, since the anti-slip member 131H is formed of a rubber material, an increase in weight due to the anti-slip member 131H can be suppressed, and thus an increase in component costs can be suppressed.

### Tenth Embodiment

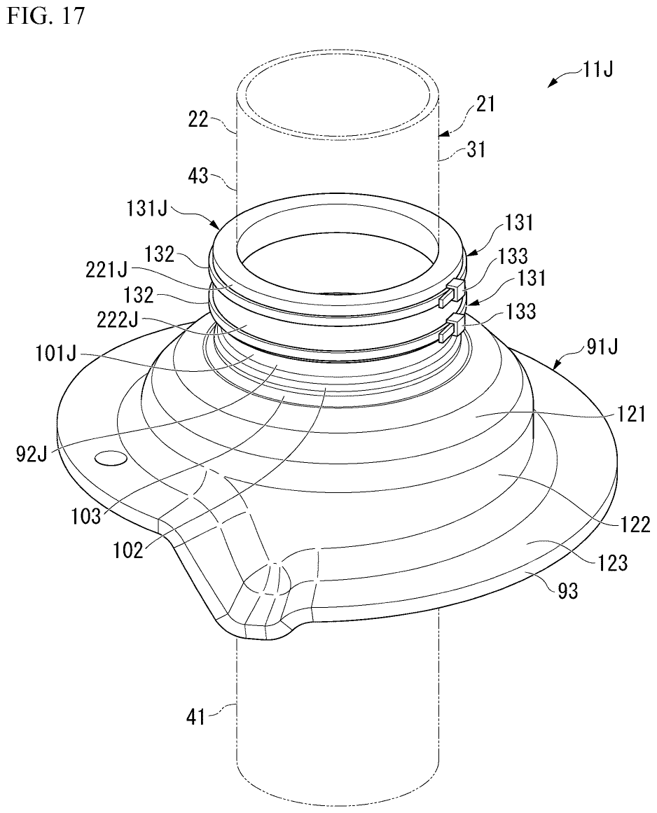

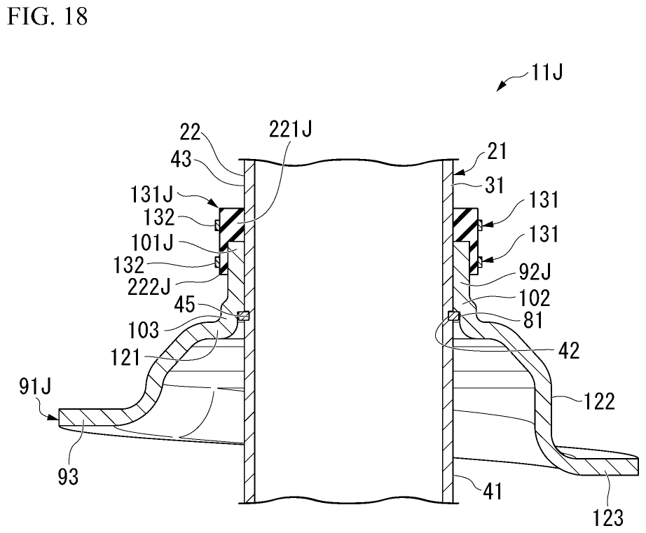

Next, a tenth embodiment will be described mainly on the basis of FIGS. 17 and 18, focusing on differences from the first embodiment. Further, parts common to those in the first embodiment will be denoted by the same terms and the same reference signs.

As shown in FIG. 17, a shock absorber 11J of the tenth embodiment includes a spring receiving member 91J, which is partially different from the spring receiving member 91, instead of the spring receiving member 91. The spring receiving member 91J has a cylindrical part 92J, which is partially different from the cylindrical part 92, instead of the cylindrical part 92. The cylindrical part 92J has a small diameter cylindrical part 101J, which is partially different from the small diameter cylindrical part 101, instead of the small diameter cylindrical part 101. As shown in FIG. 18, the small diameter cylindrical part 101J is different from the small diameter cylindrical part 101 in that the groove part 111 and the extension part 116 are not provided at a distal end portion on a side opposite to a contact part 102 in an axial direction.

The shock absorber 11J of the tenth embodiment includes an anti-slip member 131J (second movement suppression part). As shown in FIG. 17, the anti-slip member 131J is formed in an annular shape. The anti-slip member 131J is an integrally molded product made of one member formed of an elastically deformable rubber material. The anti-slip member 131J has a higher frictional coefficient than a cylinder 21 and the spring receiving member 91J.

As shown in FIG. 18, the anti-slip member 131J includes a base plate part 221J and an annular part 222J. The base plate part 221J has a cylindrical shape. The annular part 222J protrudes from an outer circumferential portion of the base plate part 221J to one side of the base plate part 221J in the axial direction. The annular part 222J has a cylindrical shape coaxial with the base plate part 221J. The annular part 222J has an inner diameter larger than an inner diameter of the base plate part 221J. An outer diameter of the annular part 222J is the same as an outer diameter of the base plate part 221J. Therefore, a radial thickness of the annular part 222J is smaller than a radial thickness of the base plate part 221J.

Similarly to the spring receiving member 91, the spring receiving member 91J fits into a second large diameter part 43 of a first cylindrical part 31 at the small diameter cylindrical part 101J of the cylindrical part 92J and fits into a contact ring 81 attached to the cylinder 21 at a large diameter cylindrical part 103 to be in contact with an end surface of the contact ring 81 on an opening 24 (see FIG. 1) side in the axial direction at the contact part 102.

In this state, the anti-slip member 131J is disposed such that the annular part 222J overlaps the small diameter cylindrical part 101J in position in an axial direction of the small diameter cylindrical part 101J. Thereby, the annular part 222J is placed in a state of facing an outer circumferential surface of the small diameter cylindrical part 101J. In other words, the anti-slip member 131J is in a state of having a surface facing the spring receiving member 91J.

Also, in this state, the anti-slip member 131J is disposed such that the base plate part 221J does not overlap the small diameter cylindrical part 101J in position, but overlaps the second large diameter part 43 of the cylinder 21 in position in the axial direction of the cylinder 21 and the small diameter cylindrical part 101J. Thereby, the base plate part 221J is placed in a state of facing the second large diameter part 43 of the cylinder 21. In other words, the anti-slip member 131J is in a state of having a surface facing the cylinder 21.

In this state, a first band member 131 is disposed to overlap the annular part 222J of the anti-slip member 131J in position in an axial direction of the anti-slip member 131J, and is wound around an outer circumferential surface of the annular part 222J. Thereafter, this band member 131 is tightened. Then, an inner circumferential surface of a strip-shaped part 132 of the band member 131 is in contact with the outer circumferential surface of the annular part 222J of the anti-slip member 131J to press the annular part 222J against the outer circumferential surface of the small diameter cylindrical part 101J of the spring receiving member 91J. Thereby, the anti-slip member 131J is in a state of facing an outer circumferential surface of the spring receiving member 91J to be in contact with and pressed against the outer circumferential surface.

Also, in this state, a second band member 131 is disposed to overlap the base plate part 221J of the anti-slip member 131J in position in the axial direction of the anti-slip member 131J, and is wound around an outer circumferential surface of the base plate part 221J. Thereafter, the band member 131 is tightened. Then, the inner circumferential surface of the strip-shaped part 132 of the band member 131 is in contact with the outer circumferential surface of the base plate part 221J of the anti-slip member 131J to press the base plate part 221J against an outer circumferential surface of the second large diameter part 43 of the cylinder 21. Thereby, the anti-slip member 131J is in a state of facing an outer circumferential surface of the cylinder 21 to be in contact with and pressed against the outer circumferential surface.

As described above, the anti-slip member 131J is in contact with an outer circumferential surface of the cylindrical part 92J of the spring receiving member 91J and the outer circumferential surface of the second large diameter part 43 of the cylinder 21, and is in a state of having a surface facing the cylindrical part 92J and a surface facing the second large diameter part 43. Also, the anti-slip member 131J faces the outer circumferential surface of the cylindrical part 92J of the spring receiving member 91J to be in contact with and pressed against the outer circumferential surface. At the same time, the anti-slip member 131J is in a state of facing the outer circumferential surface of the second large diameter part 43 of the cylinder 21 to be in contact with and pressed against the outer circumferential surface.

A pair of the band members 131 are both in a state in which the strip-shaped part 132 is fixed to the anti-slip member 131J by a frictional force of the anti-slip member 131J. At the same time, the anti-slip member 131J, the spring receiving member 91J, and the cylinder 21 are in a fixed state due to the frictional force of the anti-slip member 131J. In other words, due to the pair of band members 131 and the anti-slip member 131J, movement of the spring receiving member 91J to both sides in a circumferential direction of the cylinder 21 with respect to the cylinder 21 is suppressed, and movement thereof to both sides in the axial direction of the cylinder 21 with respect to the cylinder 21 is suppressed. In other words, the pair of band members 131 and the anti-slip member 131J are configured such that the anti-slip member 131J is in contact with the outer circumferential surface of the cylinder 21 and an outer circumferential surface of the cylindrical part 92J of the spring receiving member 91 due to a fastening force of the pair of band members 131 to suppress circumferential relative movement and axial relative movement between the cylinder 21 and the spring receiving member 91J.

Therefore, the pair of band members 131 and the anti-slip member 131J suppress the circumferential and axial relative movement between the cylinder 21 and the spring receiving member 91J by the anti-slip member 131J in contact with the outer circumferential surface of the cylinder 21 and the cylindrical part 92J of the spring receiving member 91J. The pair of band members 131 and the anti-slip member 131J include the anti-slip member 131J that is in contact with the cylinder 21 to suppress sliding with respect to the cylinder 21. Further, movement of the spring receiving member 91J to a bottom part 23 (see FIG. 1) side in the axial direction of the cylinder 21 with respect to the cylinder 21 is restricted by the contact ring 81.

In the shock absorber 11J of the tenth embodiment, the anti-slip member 131J of the pair of band members 131 and the anti-slip member 131J is in contact with the outer circumferential surface of the cylinder 21 and the cylinder-shaped cylindrical part 92J of the spring receiving member 91J that covers at least a part of the cylinder 21. Then, the pair of band members 131 and the anti-slip member 131J suppress relative movement in the circumferential direction between the cylinder 21 and the spring receiving member 91J. In this way, in the shock absorber 11J, the anti-slip member 131J of the pair of band members 131 and the anti-slip member 131J is in contact with the outer circumferential surface of the cylinder 21 and the cylindrical part 92J of the spring receiving member 91J. Therefore, in the shock absorber 11J, the anti-slip member 131J can effectively suppress relative movement in the circumferential direction between the cylinder 21 and the spring receiving member 91J due to a frictional force thereof. Also, in the shock absorber 11J, the anti-slip member 131J of the pair of band members 131 and the anti-slip member 131J is in contact with the outer circumferential surface of the cylinder 21 and the cylindrical part 92J of the spring receiving member 91J. Therefore, in the shock absorber 11J, the anti-slip member 131J can also effectively suppress relative movement in the axial direction between the cylinder 21 and the spring receiving member 91J due to the frictional force thereof. That is, in the shock absorber 11J, the pair of band members 131 and the anti-slip member 131J suppress axial movement of the spring receiving member 91J in a direction opposite to the bottom part 23 (see FIG. 1) with respect to the cylinder 21, which is not restricted by the contact ring 81, in addition to axial movement of the spring receiving member 91J in a direction of the bottom part 23 with respect to the cylinder 21, which is restricted by the contact ring 81. Therefore, in the shock absorber 11J, relative movement between the cylinder 21 and the spring receiving member 91J can be effectively suppressed. As a matter of course, in the shock absorber 11J, since the anti-slip member 131J of the pair of band members 131 and the anti-slip member 131J is in contact with the outer circumferential surface of the cylinder 21 and the cylindrical part 92J of the spring receiving member 91J, and the pair of band members 131 only need to fasten the anti-slip member 131J, deformation occurring in the cylinder 21 can be suppressed.

Also, since the shock absorber 11J uses the pair of band members 131 formed in a string shape, the pair of band members 131 can be easily attached so that the anti-slip member 131J is brought into contact with the outer circumferential surface of the cylinder 21 and the cylinder-shaped cylindrical part 92J of the spring receiving member 91J.

Also, in the shock absorber 11J, the anti-slip member 131J of the pair of band members 131 and the anti-slip member 131J is in contact with the cylinder 21 and the spring receiving member 91J to suppress sliding with respect to the cylinder 21. Therefore, the shock absorber 11J can more effectively suppress relative movement between the cylinder 21 and the spring receiving member 91J.

Also, since the anti-slip member 131J of the pair of band members 131 and the anti-slip member 131J is formed of a rubber material, the shock absorber 11J can more effectively suppress relative movement between the spring receiving member 91J and the cylinder 21. Also, in the shock absorber 11J, since the anti-slip member 131J is formed of a rubber material, the anti-slip member 131J can be easily attached to be in contact with the outer circumferential surface of the cylinder 21 and the cylindrical part 92J of the spring receiving member 91J. Moreover, in the shock absorber 11J, since the anti-slip member 131J is formed of a rubber material, an increase in weight due to the anti-slip member 131J can be suppressed, and thus an increase in component costs can be suppressed.

Further, the annular accommodation groove 211H, which is recessed radially inward from an outer circumferential surface as in the anti-slip member 131H of the ninth embodiment, may be formed on outer circumferential surfaces of the base plate part 221J and the annular part 222J. In this case, one band member 131 is wound around a groove bottom surface of the accommodation groove formed in the base plate part 221J to be tightened. Also, the other band member 131 is wound around a groove bottom surface of the accommodation groove formed in the annular part 222J to be tightened.

### Eleventh Embodiment

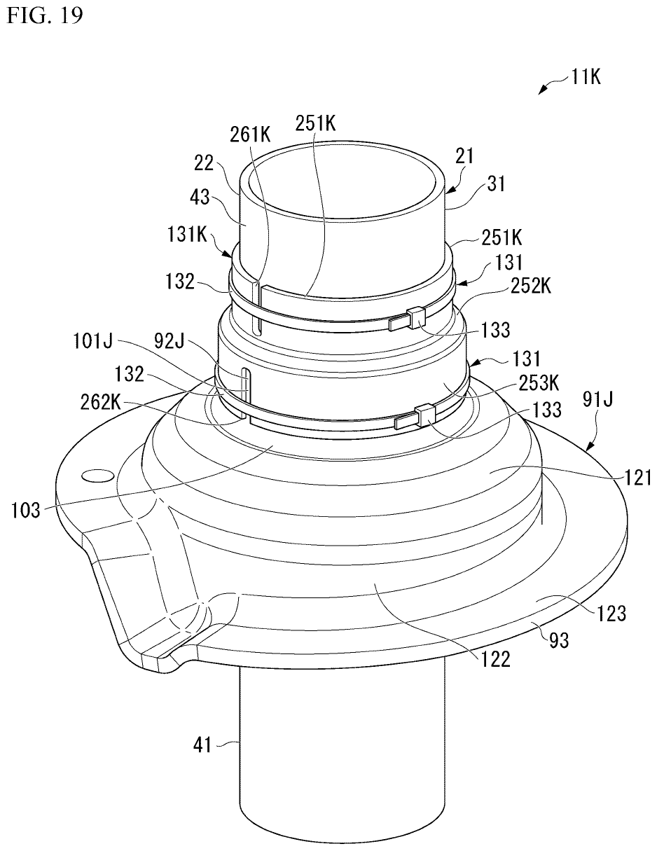

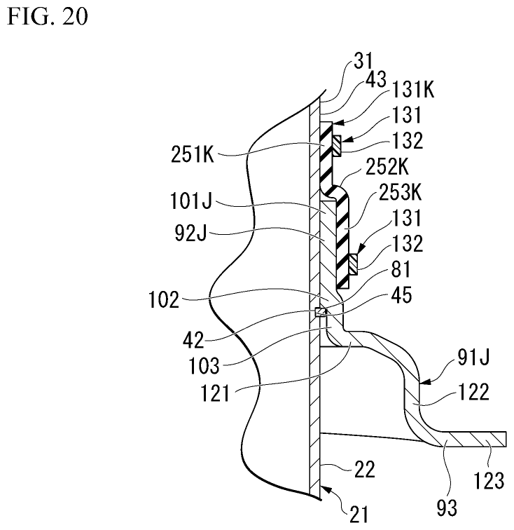

Next, an eleventh embodiment will be described mainly on the basis of FIGS. 19 and 20, focusing on differences from the tenth embodiment. Further, parts common to those in the tenth embodiment will be denoted by the same terms and the same reference signs.

As shown in FIG. 19, a shock absorber 11K of the eleventh embodiment includes a spring receiving member 91J similar to that of the shock absorber 11J.

The shock absorber 11K of the eleventh embodiment includes an anti-slip member 131K (second movement suppression part), which is partially different from the anti-slip member 131J, instead of the anti-slip member 131J. The anti-slip member 131K is formed in a cylindrical shape. The anti-slip member 131K is an integrally molded product made of one member formed of an elastically deformable rubber material. The anti-slip member 131K has a higher frictional coefficient than the spring receiving member 91J and a cylinder 21.

The anti-slip member 131K has a small diameter cylindrical part 251K, an intermediate annular part 252K, and a large diameter cylindrical part 253K.

The small diameter cylindrical part 251K has a cylindrical shape.

The intermediate annular part 252K has an annular shape. The intermediate annular part 252K extends outward in a radial direction of the small diameter cylindrical part 251K from one end of the small diameter cylindrical part 251K in an axial direction.

The large diameter cylindrical part 253K has a cylindrical shape. The large diameter cylindrical part 253K has an outer diameter larger than an outer diameter of the small diameter cylindrical part 251K. As shown in FIG. 20, the large diameter cylindrical part 253K has an inner diameter larger than an inner diameter of the small diameter cylindrical part 251K. The large diameter cylindrical part 253K extends from an outer circumferential edge portion of the intermediate annular part 252K to a side opposite to the small diameter cylindrical part 251K in the axial direction.

As shown in FIG. 19, a slit 261K extending linearly in an axial direction of the small diameter cylindrical part 251K is formed at one location in the small diameter cylindrical part 251K. The slit 261K extends from an end surface of the small diameter cylindrical part 251K on a side opposite to the intermediate annular part 252K in the axial direction to a position near the intermediate annular part 252K in the axial direction. The slit 261K penetrates the small diameter cylindrical part 251K in the radial direction of the small diameter cylindrical part 251K. A plurality of slits 261K may be formed in the small diameter cylindrical part 251K at regular intervals in a circumferential direction of the small diameter cylindrical part 251K.

A slit 262K extending linearly in an axial direction of the large diameter cylindrical part 253K is formed at one location in the large diameter cylindrical part 253K. The slit 262K extends from an end surface of the large diameter cylindrical part 253K on a side opposite to the intermediate annular part 252K in the axial direction to a position near the intermediate annular part 252K in the axial direction. The slit 262K penetrates the large diameter cylindrical part 253K in a radial direction of the large diameter cylindrical part 253K. A plurality of slits 262K may be formed in the large diameter cylindrical part 253K at regular intervals in a circumferential direction of the large diameter cylindrical part 253K.

As shown in FIG. 20, similarly to the spring receiving member 91, the spring receiving member 91J fits into a second large diameter part 43 of a first cylindrical part 31 at a small diameter cylindrical part 101J of a cylindrical part 92J and fits into a contact ring 81 attached to the cylinder 21 at a large diameter cylindrical part 103 to be in contact with an end surface of the contact ring 81 on an opening 24 (see FIG. 1) side in the axial direction at a contact part 102.

In this state, the anti-slip member 131K is disposed such that the large diameter cylindrical part 253K overlaps the small diameter cylindrical part 101J in position in an axial direction of the small diameter cylindrical part 101J of the spring receiving member 91J. Thereby, the large diameter cylindrical part 253K is placed in a state of facing an outer circumferential surface of the small diameter cylindrical part 101J. In other words, the anti-slip member 131K is in a state of having a surface facing the spring receiving member 91J. Also, in this state, the anti-slip member 131K is disposed such that the small diameter cylindrical part 251K does not overlap the small diameter cylindrical part 101J in position, but overlaps the second large diameter part 43 of the cylinder 21 in position in the axial direction of the cylinder 21 and the small diameter cylindrical part 101J. Thereby, the small diameter cylindrical part 251K is placed in a state of facing the second large diameter part 43 of the cylinder 21. In other words, the anti-slip member 131K is in a state of having a surface facing the cylinder 21.

In this state, the first band member 131 is disposed to overlap a portion of the anti-slip member 131K in which the slit 262K of the large diameter cylindrical part 253K is formed in position in an axial direction of the anti-slip member 131K, and is wound around an outer circumferential surface of the large diameter cylindrical part 253K on an outer side in the radial direction. Thereafter, the band member 131 is tightened. Then, an inner circumferential surface of the band member 131 is in contact with the large diameter cylindrical part 253K of the anti-slip member 131K to press the anti-slip member 131K against the outer circumferential surface of the small diameter cylindrical part 101J of the spring receiving member 91J. Thereby, the anti-slip member 131K is in a state of facing an outer circumferential surface of the spring receiving member 91J to be in contact with and pressed against the outer circumferential surface.

Also, in this state, the second band member 131 is disposed to overlap a portion of the anti-slip member 131K in which the slit 261K of the small diameter cylindrical part 251K is formed in position in the axial direction of the anti-slip member 131K, and is wound around an outer circumferential surface of the small diameter cylindrical part 251K of the anti-slip member 131K. Thereafter, the band member 131 is tightened. Then, an inner circumferential surface of the band member 131 is in contact with the small diameter cylindrical part 251K of the anti-slip member 131K to press the anti-slip member 131K against an outer circumferential surface of the second large diameter part 43 of the cylinder 21. Thereby, the anti-slip member 131K is in a state of facing an outer circumferential surface of the cylinder 21 to be in contact with and pressed against the outer circumferential surface.

As described above, the anti-slip member 131K is in contact with an outer circumferential surface of the cylindrical part 92J of the spring receiving member 91J and the outer circumferential surface of the second large diameter part 43 of the cylinder 21, and is in a state of having a surface facing the cylindrical part 92J and a surface facing the cylinder 21. Also, the anti-slip member 131K faces the outer circumferential surface of the cylindrical part 92J of the spring receiving member 91J to be in contact with and pressed against the outer circumferential surface. At the same time, the anti-slip member 131K is in a state of facing the outer circumferential surface of the cylinder 21 to be in contact with and pressed against the outer circumferential surface.

A pair of the band members 131 are both in a state in which a strip-shaped part 132 is fixed to the anti-slip member 131K by a frictional force of the anti-slip member 131K. At the same time, the anti-slip member 131K, the spring receiving member 91J, and the cylinder 21 are in a fixed state due to the frictional force of the anti-slip member 131K. In other words, due to the pair of band members 131 and the anti-slip member 131K, movement of the spring receiving member 91J to both sides in a circumferential direction of the cylinder 21 with respect to the cylinder 21 is suppressed, and movement thereof to both sides in the axial direction of the cylinder 21 with respect to the cylinder 21 is suppressed. In other words, the pair of band members 131 and the anti-slip member 131K are configured such that the anti-slip member 131K is in contact with the outer circumferential surface of the cylinder 21 and the outer circumferential surface of the cylindrical part 92J of the spring receiving member 91J due to a fastening force of the pair of band members 131 to suppress circumferential relative movement and axial relative movement between the cylinder 21 and the spring receiving member 91J.

Therefore, the pair of band members 131 and the anti-slip member 131K suppress the circumferential and axial relative movement between the cylinder 21 and the spring receiving member 91J by the anti-slip member 131K in contact with the outer circumferential surface of the cylinder 21 and the cylindrical part 92J. The pair of band members 131 and the anti-slip member 131K include the anti-slip member 131K that is in contact with the cylinder 21 to suppress sliding with respect to the cylinder 21. Further, movement of the spring receiving member 91J to a bottom part 23 side in the axial direction of the cylinder 21 with respect to the cylinder 21 is restricted by the contact ring 81.

In the shock absorber 11K of the eleventh embodiment, the anti-slip member 131K of the pair of band members 131 and the anti-slip member 131K is in contact with the outer circumferential surface of the cylinder 21 and the cylinder-shaped cylindrical part 92J of the spring receiving member 91J that covers at least a part of the cylinder 21. Then, in the shock absorber 11K, the pair of band members 131 and the anti-slip member 131K suppress relative movement in the circumferential direction between the cylinder 21 and the spring receiving member 91J. In this way, in the shock absorber 11K, the anti-slip member 131K of the pair of band members 131 and the anti-slip member 131K is in contact with the outer circumferential surface of the cylinder 21 and the cylindrical part 92J of the spring receiving member 91J. Therefore, the shock absorber 11K can effectively suppress relative movement in the circumferential direction between the cylinder 21 and the spring receiving member 91J due to a frictional force between the pair of band members 131 and the anti-slip member 131K. Also, in the shock absorber 11K, the anti-slip member 131K of the pair of band members 131 and the anti-slip member 131K is in contact with the outer circumferential surface of the cylinder 21 and the cylindrical part 92J of the spring receiving member 91J. Therefore, the shock absorber 11K can also effectively suppress relative movement in the axial direction between the cylinder 21 and the spring receiving member 91J due to the frictional force of the anti-slip member 131K. That is, in the shock absorber 11K, the pair of band members 131 and the anti-slip member 131K suppress axial movement of the spring receiving member 91J in a direction opposite to the bottom part 23 (see FIG. 1) with respect to the cylinder 21, which is not restricted by the contact ring 81, in addition to axial movement of the spring receiving member 91J in a direction of the bottom part 23 with respect to the cylinder 21, which is restricted by the contact ring 81. Therefore, in the shock absorber 11K, relative movement between the cylinder 21 and the spring receiving member 91J can be effectively suppressed. As a matter of course, in the shock absorber 11K, since the anti-slip member 131K of the pair of band members 131 and the anti-slip member 131K is in contact with the outer circumferential surface of the cylinder 21 and the cylindrical part 92J of the spring receiving member 91J, and the pair of band members 131 only need to fasten the anti-slip member 131K, deformation occurring in the cylinder 21 can be suppressed.

Also, since the shock absorber 11K uses the pair of band members 131 formed in a string shape, the pair of band members 131 can be easily attached so that the anti-slip member 131K is brought into contact with the outer circumferential surface of the cylinder 21 and the cylinder-shaped cylindrical part 92J of the spring receiving member 91J.

Also, in the shock absorber 11K, the anti-slip member 131K of the pair of band members 131 and the anti-slip member 131K is in contact with the cylinder 21 and the spring receiving member 91J to suppress sliding with respect to the cylinder 21. Therefore, the shock absorber 11K can more effectively suppress relative movement between the cylinder 21 and the spring receiving member 91J.

Also, since the anti-slip member 131K of the pair of band members 131 and the anti-slip member 131K is formed of a rubber material, the shock absorber 11K can more effectively suppress relative movement between the spring receiving member 91J and the cylinder 21. Also, in the shock absorber 11K, since the anti-slip member 131K is formed of a rubber material, the anti-slip member 131K can be easily attached to be in contact with the outer circumferential surface of the cylinder 21 and the cylindrical part 92J of the spring receiving member 91J. Moreover, in the shock absorber 11K, since the anti-slip member 131K is formed of a rubber material, an increase in weight due to the anti-slip member 131K can be suppressed, and thus an increase in component costs can be suppressed.

### INDUSTRIAL APPLICABILITY

According to the shock absorber according to the above-described aspect of the present invention, relative movement between the cylinder and the spring receiving member can be suppressed.

### REFERENCE SIGNS LIST

11, 11A to 11H, 11J, 11K Shock absorber
21, 21F Cylinder
31, 31F First cylindrical part (cylindrical part)
55 Piston
65 Piston rod
81, 81G Contact ring (first movement suppression part)
91, 91A to 91H, 91J Spring receiving member
92, 92A to 92H, 92J Cylindrical part
93 Seating part
111, 111D, 111E Groove part (communication part)
111A Through hole (communication part)
111B, 111H Notch part (communication part)
116F Axial protruding part
131 Band member (second movement suppression part)
131C, 131E, 131F Ring member (second movement suppression part)
131H, 131J, 131K Anti-slip member (second movement suppression part)
161D Protruding part
165D, 165E Dust cover
175E Stepped part
202G Outer serration part (second movement suppression part)

1. A shock absorber including:
a cylinder;
a piston provided inside the cylinder to be slidable; and
a piston rod connected to the piston,
the shock absorber comprising:
a first movement suppression part provided in a cylindrical part of the cylinder and protruding outward in a radial direction;
a spring receiving member including a cylinder-shaped cylindrical part covering at least a part of the cylinder, and a seating part on which a suspension spring is seated, and configured to be in contact with the first movement suppression part to suppress relative movement in an axial direction with respect to the cylinder; and
a second movement suppression part in contact with an outer circumferential surface of the cylinder and the cylindrical part to suppress relative movement in a circumferential direction between the cylinder and the spring receiving member,
wherein the second movement suppression part is formed in a string shape.

2. The shock absorber according to claim 1, wherein the spring receiving member has a communication part provided in the cylindrical part to allow communication between an outer circumferential surface of the cylinder and an outer circumferential surface side of the cylindrical part.

3. The shock absorber according to claim 2, wherein the communication part is formed so that at least a part of an axial length of the cylindrical part is reduced.

4. The shock absorber according to claim 2, wherein the communication part is a groove part formed in a notch shape from an axial end surface of the cylindrical part.

5. The shock absorber according to claim 2, wherein the communication part is a through hole provided in the cylindrical part.

6. A shock absorber including:
a cylinder;
a piston provided inside the cylinder to be slidable; and
a piston rod connected to the piston,
the shock absorber comprising:
a first movement suppression part provided in a cylindrical part of the cylinder and protruding outward in a radial direction;
a spring receiving member including a cylinder-shaped cylindrical part covering at least a part of the cylinder, and a seating part on which a suspension spring is seated, and configured to be in contact with the first movement suppression part to suppress relative movement in an axial direction with respect to the cylinder; and
a second movement suppression part in contact with an outer circumferential surface of the cylinder and the cylindrical part to suppress relative movement in a
circumferential direction between the cylinder and the spring receiving member,
wherein the spring receiving member has a communication part provided in the cylindrical part to allow communication between an outer circumferential surface of the cylinder and an outer circumferential surface side of the cylindrical part,
wherein the communication part is a groove part formed in a notch shape from an axial end surface of the cylindrical part,
wherein a protruding part protruding radially outward is formed on an axial end surface of the groove part, and
wherein axial movement of at least a part of a dust cover, which covers at least a part of the cylinder or at least a part of the cylindrical part, is suppressed by the protruding part.

7. A shock absorber including:
a cylinder;
a piston provided inside the cylinder to be slidable; and
a piston rod connected to the piston,
the shock absorber comprising:
a first movement suppression part provided in a cylindrical part of the cylinder and protruding outward in a radial direction;
a spring receiving member including a cylinder-shaped cylindrical part covering at least a part of the cylinder, and a seating part on which a suspension spring is seated, and configured to be in contact with the first movement suppression part to suppress relative movement in an axial direction with respect to the cylinder; and
a second movement suppression part in contact with an outer circumferential surface of the cylinder and the cylindrical part to suppress relative movement in a circumferential direction between the cylinder and the spring receiving member,
wherein the spring receiving member has a communication part provided in the cylindrical part to allow communication between an outer circumferential surface of the cylinder and an outer circumferential surface side of the cylindrical part,
wherein the communication part is a groove part formed in a notch shape from an axial end surface of the cylindrical part,
wherein the second movement suppression part has a stepped part formed so that a part of an outer circumferential surface is stepped, and
wherein axial movement of at least a part of a dust cover, which covers at least a part of the cylinder or at least a part of the cylindrical part, is suppressed by the stepped part.

8. (canceled)

9. The shock absorber according to claim 1, wherein the second movement suppression part is formed of a resin material or a rubber material.

10.-11. (canceled)

12. A shock absorber including:
a cylinder;
a piston provided inside the cylinder to be slidable; and
a piston rod connected to the piston,
the shock absorber comprising:
a spring receiving member provided on an outer circumferential surface side of the cylinder, and including a cylinder-shaped cylindrical part covering at least a part of the cylinder, and a seating part on which a suspension spring is seated;
a first movement suppression part provided on an outer circumferential surface of the cylinder and suppressing movement of the spring receiving member in an axial direction;
a communication part provided in the cylindrical part to allow communication between an outer circumferential surface side of the cylinder and an outer circumferential surface side of the cylindrical part; and
a second movement suppression part having at least a part of an inner circumferential surface in contact with an outer circumferential surface of the cylindrical part and an outer circumferential surface of the cylinder, and having a surface facing the cylindrical part and a surface facing the cylinder.

13. The shock absorber according to claim 1, wherein the second movement suppression part includes an anti-slip member which is in contact with the cylinder to suppress sliding with respect to the cylinder.
